(19) United States
(12) Patent Application Publication
(10) Pub. No.: US 2015/0293700 A1
(43) Pub. Date: Oct. 15, 2015

(54) CONTROL APPARATUS AND CONTROL METHOD

(71) Applicant: FUJITSU LIMITED, Kawasaki-shi (JP)

(72) Inventor: Kazuki Sasaki, Kawasaki (JP)

(21) Appl. No.: 14/641,892

(22) Filed: Mar. 9, 2015

(30) Foreign Application Priority Data
Apr. 9, 2014 (JP) 2014-079845

(51) Int. Cl. G06F 3/06; G06F 12/08

(52) U.S. Cl. CPC G06F 3/061; G06F 3/0689; G06F 3/0665; G06F 12/0866; G06F 3/0643; G06F 3/0686; G06F 2212/2146

(57) ABSTRACT

A control apparatus includes: a storage unit configured to store information of a designated compression parameter value and information of a compression parameter value calculated from a data size of a data file with respect to the data file compressed with the designated compression parameter value that represents a reduction degree of the data size and stored in a storage device; and a controller configured to compare, in terms of the reduction degree, the designated compression parameter value and the calculated compression parameter value for each data file, and set a recompression target by extracting the data file in which the calculated compression parameter value is lower than the designated compression parameter value.

### CROSS-REFERENCE TO RELATED APPLICATION

This application is based upon and claims the benefit of priority of the prior Japanese Patent Application No. 2014-079845, filed on Apr. 9, 2014, the entire contents of which are incorporated herein by reference.

### FIELD

The embodiments discussed herein are related to a control apparatus and a control method.

### BACKGROUND

Tape library systems using high capacity volume tape media are widely used in applications that back up large volumes of data handled by a data center or the like. The tape library system includes a library apparatus that executes the management of a tape medium and reading and writing of data with respect to the tape medium. The library apparatus includes, for example, a plurality of storage slots that store tape media, a physical drive that reads and writes data to the tape media, and a robot that transports the tape media from the storage slots to a physical drive.

In a case of writing data on the tape medium, the library apparatus removes the tape medium from the storage slot by controlling the robot. The library apparatus mounts the removed tape medium to the physical drive. The library apparatus writes the data on the tape medium via the physical drive. In a case of reading data from the tape medium, similarly, processes of removing the tape medium, mounting the tape medium to the physical drive, and the like also occur. In this way, in the library apparatus, mechanical operations are interposed when accessing data in the tape medium.

When the mechanical operations are interposed during the data access as above, data reading speed and data writing speed are lowered. In view of these circumstances, a virtual library system in which the tape medium is virtualized using a disk array, and the speed of the reading and writing process is increased during the data access has been proposed. For example, there is a virtual library system that incorporates a virtual tape device that includes a disk array between the host computer and the library apparatus, and treats the reading and writing with respect to a logical volume on the disk array as virtual reading and writing of the tape medium.

In the virtual library system, the logical volume is built on the disk array and the drive (logical drive) that mounts the logical volume is also logically built. Therefore, reading and writing of the data occurs with respect to the logical volume and a high speed data reading and writing process is realized without interposing a mechanical operation when mounting the logical volume to the logical drive. The disk array has a higher data access performance as compared to the tape medium and contributes to higher speed reading and writing of data. The data of the logical volume is saved from the disk array to the tape medium in a case in which set conditions are satisfied or a case in which a request is received from a host computer.

High speed reading and writing of the data as described above is realized in a condition in which the logical volume is stored on the disk array. In a case in which the logical volume is not stored on the disk array, a process of storing logical volume to the disk array by reading the logical volume from the tape medium occurs. In this case, mechanical operations occur within the library apparatus and a long time is taken for data access. Therefore, if the disk array stores as many logical volumes as the storage capacity of the disk array permits, it is possible to expect an increase in the data access performance.

As a method for storing a larger data file in a storage region in which the storage capacity is limited, there are methods of compressing the stored data. With respect to the compression technology, a method that compresses a page with a relatively low value among the pages in memory has been proposed. A data transmission method that selects the compression method for transmission data in response to data volume or type of the transmission data has also been proposed. A method relating to a virtual tape device in which whether or not to apply compression to the data stored in the storage device is set in advance has also been proposed.

Japanese Laid-open Patent Publication No. 2004-133934, Japanese Laid-open Patent Publication No. 2005-192157, Japanese Laid-open Patent Publication No. 2005-99971, and Japanese Laid-open Patent Publication No. 11-143748 are examples of the related art.

The compression rate of the data file stored in the logical volume is designated by the host computer. However, the effect of compression is dependent on the content or the like of the data file. Therefore, even if a compression process is executed by designating the compression rate, there are cases in which the actual compression rate calculated from the data size of both pre- and post-compression does not reach the designated compression rate. In order to increase the number of logical volumes able to be stored on the disk array, when the data file is recompressed with a compression strength stronger than the compression strength that is indicated by the compression rate during the previous compression, if recompression is executed up to a data file for which a compression effect is not expected, the processing load is wastefully increased.

### SUMMARY

According to an aspect of the embodiments, a control apparatus includes: a storage unit configured to store information of a designated compression parameter value and information of a compression parameter value calculated from a data size of a data file with respect to the data file compressed with the designated compression parameter value that represents a reduction degree of the data size and stored in a storage device; and a controller configured to compare, in terms of the reduction degree, the designated compression parameter value and the calculated compression parameter value for each data file, and set a recompression target by extracting the data file in which the calculated compression parameter value is lower than the designated compression parameter value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system according to a first embodiment;

FIG. 2 is a diagram illustrating an example of a virtual library system according to a second embodiment;

FIG. 3 is a diagram illustrating a flow of read processing in the virtual library system;

FIG. 4 is a diagram illustrating a flow of write processing in the virtual library system;

FIG. 5 is a diagram illustrating an example of hardware able to realize a function of a host computer according to the second embodiment;

FIG. 6 is a diagram for illustrating the function included in a robot control server according to the second embodiment;

FIG. 7 is a diagram for illustrating the function included in a drive control server according to the second embodiment;

FIG. 8 is a diagram for illustrating the function included in a channel control server according to the second embodiment;

FIG. 9 is a diagram for illustrating the function included in a virtual library control server according to the second embodiment;

FIG. 10 is a diagram illustrating an example of a logical volume (LV) state information table according to the second embodiment;

FIG. 11 is a diagram illustrating an example of an intra-LV file information table according to the second embodiment;

FIG. 12 is a diagram illustrating an example of an intra-LV file access statistics table according to the second embodiment;

FIG. 13 is a diagram illustrating an example of an intra-LV file compression information table according to the second embodiment;

FIG. 14 is a diagram illustrating an example of a recompression processing job management table according to the second embodiment;

FIG. 15 is a diagram illustrating an example of an integrated channel processor (ICP) load information table according to the second embodiment;

FIG. 16 is a diagram for illustrating updating of the recompression processing job management table (updating after unmount condition determination) according to the second embodiment;

FIG. 17 is a diagram for illustrating updating of the recompression processing job management table (in the case where main processing occurs during execution of recompression) according to the second embodiment;

FIG. 18 is a diagram illustrating an example of notification information to the host computer according to the second embodiment;

FIG. 19 is a flowchart illustrating update processing of the intra-LV file access statistics table according to the second embodiment;

FIG. 20 is a flowchart illustrating update processing of the intra-LV file compression information table according to the second embodiment;

FIG. 21 is a flowchart illustrating a recompression job creation process according to the second embodiment;

FIG. 22 is a first flowchart illustrating the flow of recompression processing according to the second embodiment;

FIG. 23 is a second flowchart illustrating the flow of recompression processing according to the second embodiment;

FIG. 24 is a diagram illustrating an example of an LV state information table according to the third embodiment;

FIG. 25 is a diagram illustrating an example of an LV state information table according to the third embodiment;

FIG. 26 is a diagram illustrating an example of an LV state information table according to the third embodiment;

FIG. 27 is a diagram illustrating an example of an intra-LV file compression information table according to the third embodiment;

FIG. 28 is a diagram illustrating an example of a recompression processing job management table according to the third embodiment;

FIG. 29 is a diagram illustrating an example of the priority information according to the third embodiment;

FIG. 30 is a diagram for illustrating updating of the recompression processing job management table (updating after unmount condition determination) according to the third embodiment;

FIG. 31 is a diagram for illustrating updating of the recompression processing job management table (in the case where main processing occurs during execution of recompression) according to the third embodiment;

FIG. 32 is a diagram illustrating an example of notification information to the host computer according to the third embodiment;

FIG. 33 is a flowchart illustrating update processing of the intra-LV file compression information table according to the third embodiment;

FIG. 34 is a first flowchart illustrating a recompression job creation process according to the third embodiment;

FIG. 35 is a second flowchart illustrating a recompression job creation process according to the third embodiment;

FIG. 36 is a first flowchart illustrating the flow of recompression processing according to the third embodiment; and

FIG. 37 is a second flowchart illustrating the flow of recompression processing according to the third embodiment.

### DESCRIPTION OF EMBODIMENTS

Hereinafter, embodiments of the disclosure will be described below with reference to the attached drawings. Elements having substantially the same functions in the description and the drawings are given the same references and overlapping description may not be repeated.

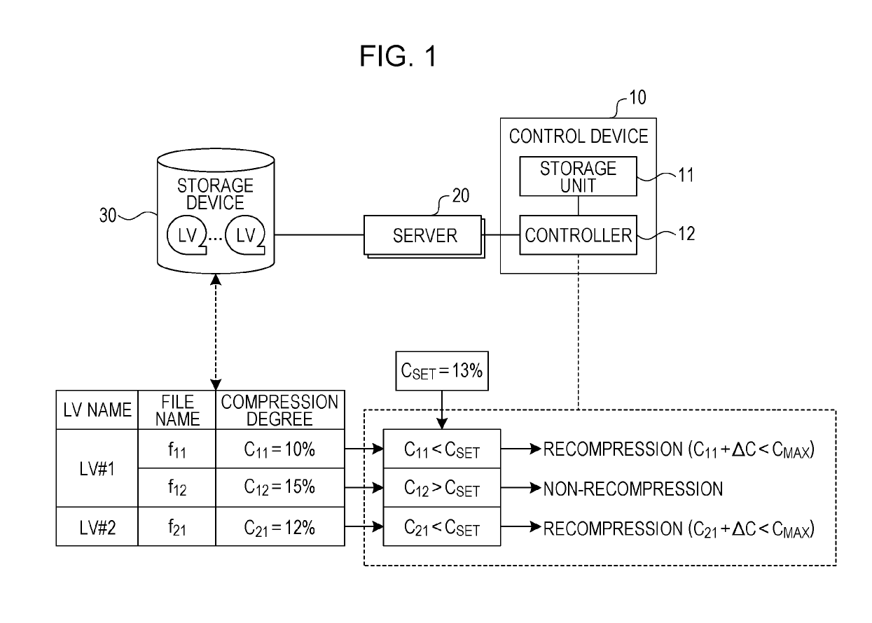

The first embodiment will be described with reference to FIG. 1. FIG. 1 is a diagram illustrating an example of a system according to a first embodiment.

As illustrated in FIG. 1, the system according to the first embodiment includes a control device 10, a server 20, and a storage device 30.

The virtual tape device arranged between the host computer and the library device is an example of the system according to the first embodiment. Although one server 20 is given as an example in the example in FIG. 1, the number of servers 20 may be two or more. A logical volume (LV) that is an example of a storage region that stores the data file is stored in the storage device 30.

The control device 10 includes a storage unit 11 and a controller 12.

The storage unit 11 is a volatile storage device, such as a random access memory (RAM), or is a non-volatile storage device, such as a hard disk drive (HDD) or a flash memory. The controller 12 is a processor such as a central processing unit (CPU) or a digital signal processor (DSP). However, the controller 12 may be an electronic circuit such as an application specific integrated circuit (ASIC) or a field programmable gate array (FPGA). The controller 12 executes programs stored in the storage unit 11 or other memory.

In the example in FIG. 1, although two logical volumes LV#1 and LV#2 are stored in the storage device 30 for convenience of description, there may be two or more volumes. Two data files f₁₁ and f₁₂ are stored in the logical volume LV#1. One data file f₂₁ is stored in the logical volume LV#2. The data files f₁₁, f₁₂, and f₂₁ are stored in the storage regions LV#1 and LV#2 upon being compressed with a designated compression degree C_{SET} that indicates the degree of reduction in the data size due to compression. The compression degree C_{SET} is a compression degree designated in advance by the host computer or is a compression degree designated during the previous recompression.

Examples of indices able to be utilized in expressing the compression degree include the data compression ratio, the space savings rate, and the compression rate. The data compression ratio is a value obtained by dividing the pre-compression data size by the post-compression data size. The space savings rate is a value in which the value obtained by dividing the post-compression data size by the pre-compression data size is subtracted from 1. The compression rate used in the specification is a value obtained by dividing the pre-compression data size by the post-compression data size. The compression degree above is an index for which the value increases as the post-compression data size decreases compared to pre-compression. Accordingly, it is possible for the compression degree above to be expressed using the data compression ratio, the space savings rate, reciprocal of the compression rate, and the like. The compression degree, the data compression ratio, the space savings rate, the compression rate, and the like are often referred to as the compression parameter.

The storage unit 11 stores information of the designated compression degree C_{SET} and information of the compression degrees C₁₁, C₁₂, and C₂₁ calculated based on the data size of data files with respect to the data files f₁₁, f₁₂, and f₂₁. The controller 12 compares the designated compression degree C_{SET} and the calculated compression degrees C₁₁, C₁₂, and C₂₁ for each data file. The controller 12 sets the recompression target by extracting the data files f₁₁ and f₂₁ for which the calculated compression degree is the designated compression degree or higher.

The controller 12 designates the compression degree and recompresses the data file on the server 20. In the example in FIG. 1, the designated compression degree C_{SET} is 13% and the compression degrees C₁₁, C₁₂, and C₂₁ are 10%, 15%, and 12%, respectively. Accordingly, the controller 12 makes the data files f₁₁ and f₂₁ recompression targets. The controller 12 does not make the data file f₁₂ a recompression target. The controller 12 sets the compression degree to be used during recompression of the data file f₁₁ to (C₁₁+ΔC). However, in a case in which the compression degree (C₁₁+ΔC) is the maximum compression degree C_{MAX} or higher, the controller 12 sets the compression degree to be used during recompression to C_{MAX}.

The controller 12 sets the compression degree to be used during recompression of the data file f₂₁ to (C₂₁+ΔC). However, in a case in which the compression degree (C₂₁+ΔC) is the maximum compression degree C_{MAX} or higher, the controller 12 sets the compression degree to be used during recompression to C_{MAX}. However, ΔC is a value set in advance. For example, a value of “ΔC=5%” or the like is set.

As above, by making the data file for which the calculated compression degree reaches the designated compression degree C_{SET} the recompression target, it is possible for a compression process without prospect of effect to be avoided and for the processing efficiency during recompression to be improved. By the data file being compressed at a higher compression degree than the designated compression degree C_{SET} in accordance with the compression degree of the data file, the logical volume LV stored in the storage device 30 is capable of being increased. As a result, it is possible to expect an improvement in the data access performance.

2-1. System

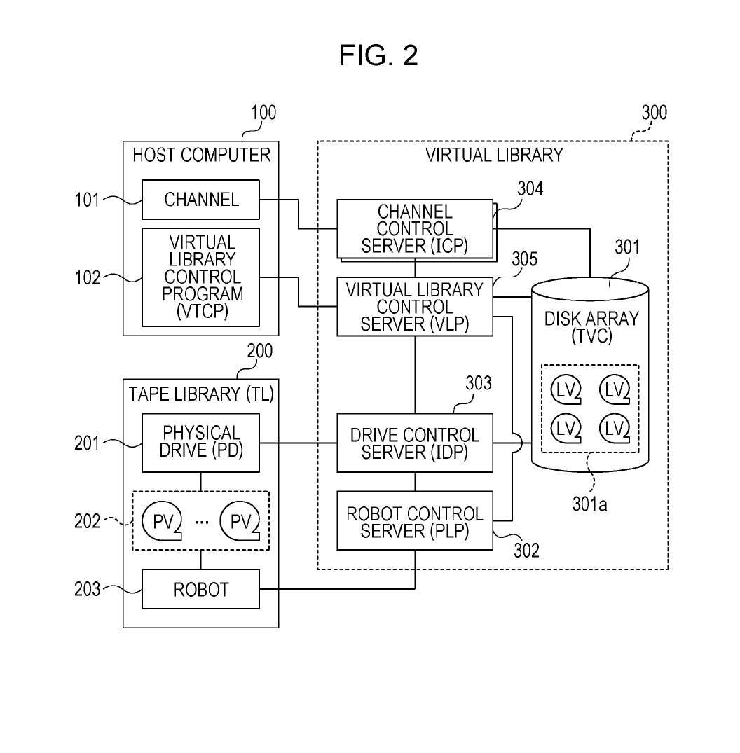

The virtual library system according to the second embodiment will be described with reference to FIG. 2. FIG. 2 is a diagram illustrating an example of a virtual library system according to a second embodiment.

As illustrated in FIG. 2, the virtual library system according to the second embodiment includes a host computer 100, a tape library 200, and a virtual library 300.

Host Computer 100

The host computer 100 includes a channel 101 and a virtual library control program 102. The virtual library control program 102 in the specification may be denoted as a virtual tape control program (VTCP).

The channel 101 executes the read processing and the write processing with respect to the logical volume LV by building a channel with the virtual library 300. In the following description, the read processing and the write processing may be referred to as main processing. The virtual library control program 102 requests the virtual library 300 to mount the logical volume LV that is the target of main processing to the logical drive LD. After the logical volume LV is mounted to the logical drive LD in response to the request, main processing is executed by the channel 101.

Tape Library 200

The tape library 200 includes a physical drive 201, a storage slot 202 in which the physical volume (PV) is stored, and a robot 203. The tape library 200 in the specification may also be denoted as a tape library (TL). The physical drive 201 may also be denoted as a physical drive (PD).

The physical volume PV is mounted to the physical drive 201. The physical drive 201 reads data on the mounted physical volume PV and writes data to the mounted physical volume PV. For example, the physical drive 201 reads out data of the logical volume LV from the mounted physical volume PV. The physical drive 201 writes data of the logical volume LV to the mounted physical volume PV.

The physical volume PV is, for example, a tape medium. A tape cartridge in which a magnetic tape is wound on a reel in a protective case referred to as a cartridge is used as the tape medium. The physical volume PV not mounted to the physical drive 201 is stored in a storage slot 202 in the tape library 200. The mounting target physical volume PV is removed from the storage slot 202 by the robot 203, and is mounted to the physical drive 201. A plurality of physical drives 201 and robots 203 may be provided in the tape library 200.

Virtual Library 300

The virtual library 300 includes a disk array 301, a robot control server 302, a drive control server 303, a channel control server 304, and a virtual library control server 305.

The disk array 301 in the specification may be denoted as a tape volume cache (TVC). The robot control server 302 may be denoted as a physical library processor (PLP). The drive control server 303 may be denoted as an integrated device processor (IDP). The channel control server 304 may be denoted as an integrated channel processor (ICP). The virtual library control server 305 may be denoted as a virtual library processor (VLP).

The disk array 301 is an example of the storage device. For example, the disk array 301 is a redundant array of inexpensive (or independent) disks (RAID) device in which a plurality of recording media are combined. A hard disk drive (HDD), solid state drive (SSD), or the like is utilized as the recording medium. The disk array 301 includes a storage region 301a that stores data of the logical volume LV.

The robot control server 302 controls the operation of the robot 203 included in the tape library 200. For example, the robot control server 302 controls the operation of the robot 203 in accordance with instructions received from the virtual library control server 305, and the physical volume PV is mounted to the physical drive 201.

The drive control server 303 stores (saves) the data of the logical volume LV stored in the storage region 301a of the disk array 301 on the physical volume PV. The drive control server 303 stores (restores) the data of the logical volume LV stored on the physical volume PV in the storage region 301a of the disk array 301. At this time, the drive control server 303 writes data of the logical volume LV to the physical volume PV via the physical drive 201 and reads out data of the logical volume LV from the physical volume PV.

The channel control server 304 includes a channel interface card for connecting to the host computer 100. The channel control server 304 realizes the functions of a virtual drive that includes a function of a logical drive LD in which the physical drive 201 is virtualized. The virtual library control server 305 is connected to the host computer 100 and controls the mounting and unmounting of the logical volume LV to the logical drive LD in response to a request received from the host computer 100. The virtual library control server 305 executes management of the logical volume LV, management of the physical volume PV and requests for saving and restoring, and the like.

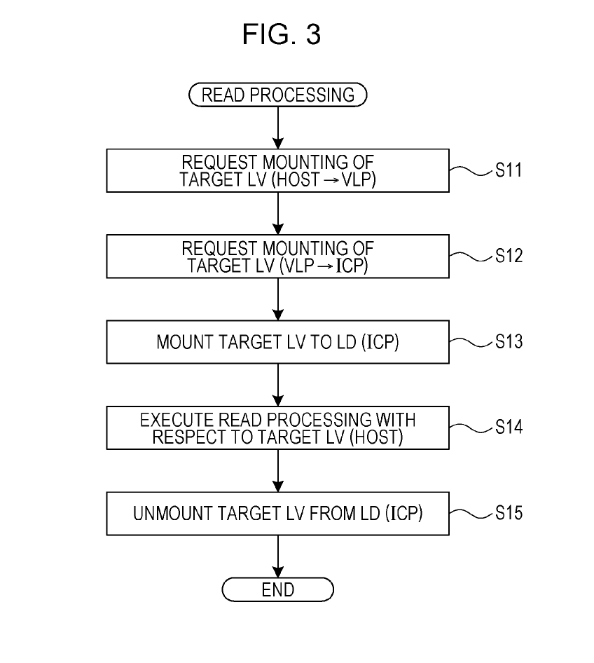

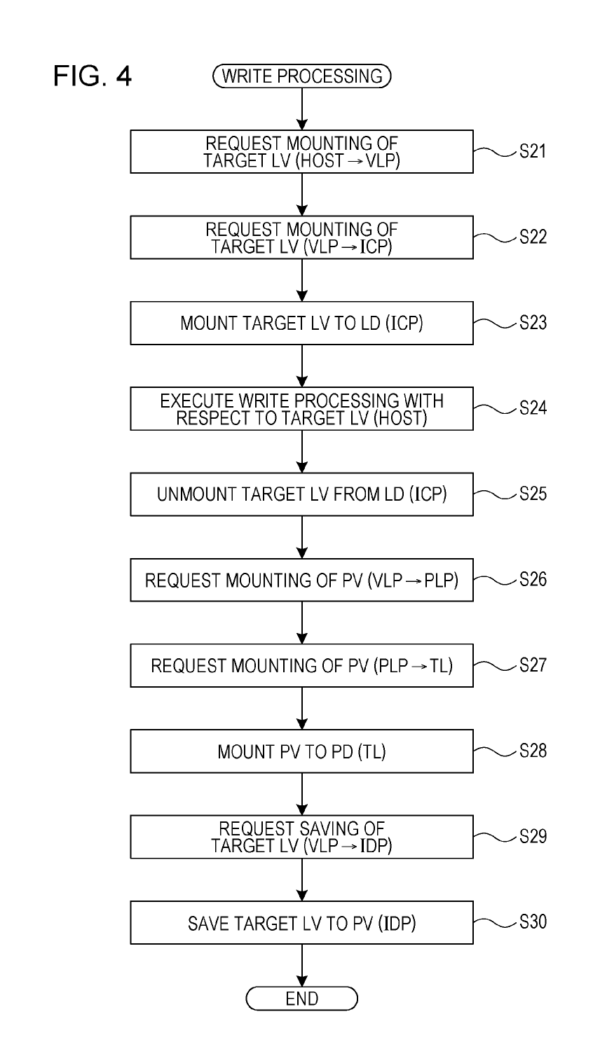

Here, the read processing and write processing of the data with respect to logical volume LV will be described with reference to FIGS. 3 and 4.

Flow of Read Processing

The read processing will be described with reference to FIG. 3. FIG. 3 is a diagram illustrating the flow of read processing in the virtual library system.

(S11) The virtual library control program 102 of the host computer 100 requests the virtual library control server 305 of the virtual library 300 to mount the logical volume LV that is the read processing target to the logical drive LD.

(S12) The virtual library control server 305 that receives the request confirms whether or not the logical volume LV that is the read processing target is present in the storage region 301a of the disk array 301. In a case in which the logical volume LV that is the read processing target is present in the storage region 301a, the virtual library control server 305 requests the channel control server 304 to mount the logical volume LV to the logical drive LD.

In a case in which the logical volume LV that is the read processing target is not present in the storage region 301a, the virtual library control server 305 restores the logical volume LV to the storage region 301a by controlling the robot control server 302 and the drive control server 303. The virtual library control server 305 requests the channel control server 304 to mount the restored logical volume LV to the logical drive LD.

(S13) The channel control server 304 acquires the logical volume LV that is the read processing target from the storage region 301a of the disk array 301 and mounts the acquired logical volume LV to the logical drive LD in an unused state.

(S14) The channel 101 of the host computer 100 executes the read processing with respect to the logical volume LV mounted to the logical drive LD via the channel control server 304.

(S15) When the read processing is completed, the channel control server 304 unmounts the logical volume LV that is the read processing target from the logical drive LD. The channel control server 304 stores the logical volume LV in the storage region 301a of the disk array 301. When the process in S15 is completed, the series of processes illustrated in FIG. 3 finishes.

Flow of Write Processing

Next, the write processing will be described with reference to FIG. 4. FIG. 4 is a diagram illustrating a flow of write processing in the virtual library system.

(S21) The virtual library control program 102 of the host computer 100 requests the virtual library control server 305 of the virtual library 300 to mount the logical volume LV that is the write processing target to the logical drive LD.

(S22) The virtual library control server 305 that receives the request confirms whether or not the logical volume LV that is the write processing target is present in the storage region 301a of the disk array 301. In a case in which the logical volume LV that is the write processing target is present in the storage region 301a, the virtual library control server 305 requests the channel control server 304 to mount the logical volume LV to the logical drive LD.

In a case in which the logical volume LV that is the write processing target is not present in the storage region 301a, the virtual library control server 305 restores the logical volume LV to the storage region 301a by controlling the robot control server 302 and the drive control server 303. The virtual library control server 305 requests the channel control server 304 to mount the restored logical volume LV to the logical drive LD.

(S23) The channel control server 304 acquires the logical volume LV that is the write processing target from the storage region 301a of the disk array 301, and mounts the acquired logical volume LV to the logical drive LD in an unused state.

(S24) The channel 101 of the host computer 100 executes the write processing with respect to the logical volume LV mounted to the logical drive LD via the channel control server 304.

(S25) When the write processing is completed, the channel control server 304 unmounts the logical volume LV that is the write processing target from the logical drive LD. The channel control server 304 stores the logical volume LV after the write processing in the storage region 301a of the disk array 301. At this time, the logical volume LV in which data is updated by the write process is not saved in others than in the storage region 301a of the disk array 301. The state may be referred to as a “Dirty” state.

(S26) The virtual library control server 305 requests the robot control server 302 to mount an arbitrary physical volume PV to an arbitrary physical drive 201.

(S27) The robot control server 302 mounts the arbitrary physical volume PV to the arbitrary physical drive 201 by controlling the robot 203 of the tape library 200.

(S28) The robot 203 acquires the physical volume PV from the storage slot 202 by receiving control by the robot control server 302 and mounts the acquired physical volume PV to the physical drive 201.

(S29) The virtual library control server 305 requests the drive control server 303 to store the logical volume LV after the write processing to the physical volume PV.

(S30) The drive control server 303 acquires the logical volume LV after the write processing from the storage region 301a of the disk array 301 and stores the logical volume LV to the physical volume PV which is mounted to the physical drive 201. When the process in S30 is completed, the series of processes illustrated in FIG. 4 finishes.

Above, the virtual library system according to the second embodiment has been described with reference to FIG. 2.

With the above mechanism, the virtual server 300 emulates the tape library system (tape emulation) using the functions of various servers. In tape emulation, the disk array 301 appears, to the host computer 100, to be a collection of virtual physical volumes PV.

In a case in which the write processing is executed from the host computer 100, the data is saved to the logical volume LV. The data saved to the logical volume LV is saved, in the background, to the physical volume PV in the tape library 200 connected to the back end of the virtual library 300. In this way, the saving of the data handled by the virtual library 300 is duplexed and the safety and reliability of the data are ensured.

In a case in which the logical volume LV that is the processing target is present in the disk array 301, the read processing and write processing executed in the virtual library 300 are not interposed by a mechanical operation including transport of the physical volume PV by the robot 203. Therefore, the read processing and write processing executed in the virtual library 300 are performed at high speed compared to a process that writes data directly to the physical volume PV and reads data directly from the physical volume PV.

On the other hand, in a case in which the logical volume LV that is the processing target is not present on the disk array 301, a mechanical operation in the tape library 200 is interposed during the read processing and write processing. Therefore, the virtual library 300 holds as many logical volumes LV on the disk array 301 as the storage capacity of the disk array 301 permits. In a case in which the storage capacity of the disk array 301 is insufficient due to the write process for new data to the logical volume LV, a portion of the logical volume LV is saved to the physical volume PV. The logical volume LV that is the saving target is extracted using, for example, a least recently used (LRU) algorithm.

In the virtual library system, because the above operation is performed, if the storage capacity of the disk array 301 is used efficiently and the disk array 301 holds as many logical volumes LV as possible, it is possible to expect an improvement in the disk access performance. In light of the above reason, when data is stored on the logical volume LV, the storage target data is subjected to compression processing. In the second embodiment, a mechanism in which the compression state of the data stored on the logical volume LV is managed and the disk access performance is improved by suitably controlling the compression state is proposed.

2-2. Hardware

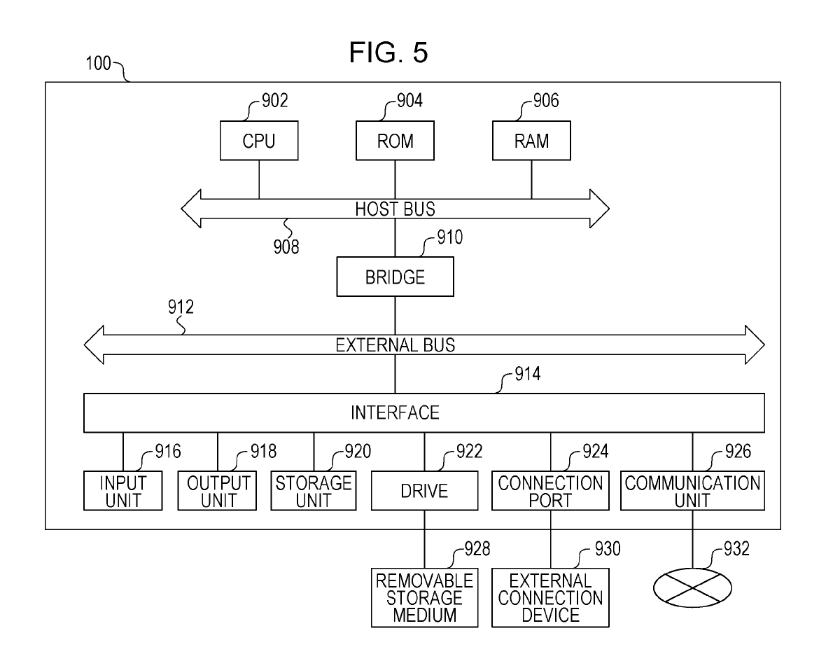

Here, the hardware able to realize the function included in the host computer 100 will be described with reference to FIG. 5. FIG. 5 is a diagram illustrating an example of hardware able to realize a function of a host computer according to the second embodiment.

The functions included in the host computer 100 are able to be realized using hardware resources of the information processing device illustrated in FIG. 5. In other words, the functions included in the host computer 100 are realized by controlling the hardware illustrated in FIG. 5 using a computer program.

As illustrated in FIG. 5, the hardware mainly includes a CPU 902, a read only memory (ROM) 904, a RAM 906, a host bus 908, and a bridge 910. The hardware further includes an external bus 912, an interface 914, an input unit 916, an output unit 918, a storage unit 920, a drive 922, a connection port 924, and a communication unit 926.

The CPU 902 functions as a calculation processing device and a control device and controls the overall operation of each constituent element or a part thereof based on various programs recorded in the ROM 904, RAM 906, the storage unit 920 or the removable recording medium 928. The ROM 904 is an example of a storage device that stores the program read by the CPU 902 and data or the like used in calculation. The program read by the CPU 902 or various parameters that change when executing the program is temporarily or persistently stored in the RAM 906.

These elements are connected to one another via the host bus 908 capable of high speed data transfer. Meanwhile, the host bus 908 is connected to an external bus 912 with a comparatively low data transfer speed via the bridge 910. A mouse, keyboard, touch panel, touch pad, button, switch, lever, and the like are used as the input unit 916. A remote controller capable of transmitting control signals by using infrared rays or other electrical waves is also used as the input unit 916.

A display device, such as a cathode ray tube (CRT), liquid crystal display (LCD), plasma display panel (PDP) or electro-luminescence display (ELD), is uses as the output unit 918. An audio output device, such as a speaker or headphones, or a printer is also used as the output unit 918. In other words, the output unit 918 is a device capable of visually or audibly outputting information.

The storage unit 920 is a device for storing a variety of data. A magnetic storage device, such as an HDD is used as the storage unit 920. A semi-conductor storage device, such as a solid state drive (SSD) or a RAM disk, an optical storage device or a magneto-optical storage device or the like may also be used as the storage unit 920.

The drive 922 is a device that reads out information recorded on the removable recording medium 928 that is a recording medium able to be attached and detached or writes information to the removable recording medium 928. For example, a magnetic disk, an optical disc, a magneto-optical disc, a semiconductor memory, or the like is used as the removable recording medium 928.

The connection port 924 is a port for connecting to an external connection device 930, such as a universal serial bus (USB), IEEE 1394 port, small computer system interface (SCSI), RS-232C port or an optical audio terminal. A printer or the like is used as the external connection device 930.

The communication unit 926 is a communication device for connecting to a network 932. For example, a communication circuit for a wired or wireless local area network (LAN), a communication circuit for wireless USB (WUSB), a communication circuit or router for optical communication, a communication circuit or router for asymmetric digital subscriber line (ADSL), a communication circuit for a mobile telephone network or the like is used as the communication unit 926. The network 932 connected to the communication unit 926 is a network that is wired or wirelessly connected and includes the Internet, a LAN, a broadcast network, a satellite communication circuit or the like.

Here, hardware able to realize the functions included in the host computer 100 is described. The functions included in various servers included in the virtual library 300 are able to be realized using a part or all of the hardware illustrated as an example in FIG. 5. Accordingly, the hardware of the various servers included in the virtual library 300 will not be described.

2-3. Functions of Various Servers

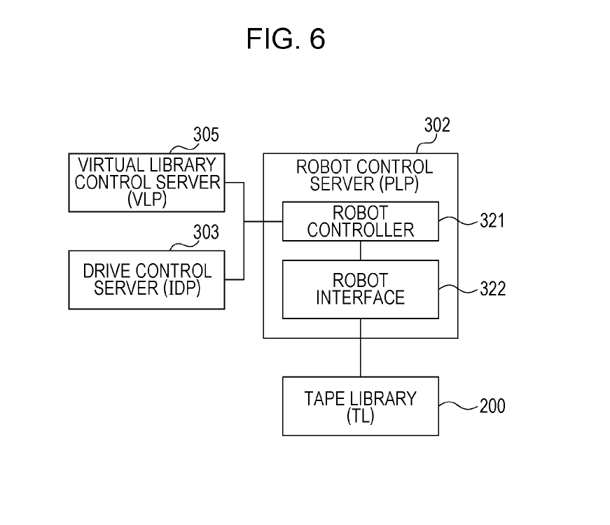

Next, the functions of the various servers included in the virtual library 300 will be further described with reference to FIGS. 6 to 18.

2-3-1. Robot Control Server (PLP)

First, the functions of the robot control server 302 will be further described with reference to FIG. 6. FIG. 6 is a diagram for illustrating the functions included in a robot control server according to the second embodiment.

As illustrated in FIG. 6, the robot control server 302 includes a robot control unit 321 and a robot interface 322. It is possible to realize the functions of the robot control unit 321 using the above-described CPU 902.

The robot control unit 321 controls the robot 203 of the tape library 200 and acquires the physical volume PV from the storage slot 202 and mounts the volume to the physical drive 201. The robot control unit 321 controls the robot 203 of the tape library 200, unmounts the physical volume PV from the physical drive 201, and stores the physical volume PV in the storage slot 202.

The robot interface 322 is an interface for connecting the robot control server 302 and the robot 203. The robot control unit 321 controls the robot 203 via the robot interface 322. For example, the robot control unit 321 executes a process of mounting or unmounting the physical volume PV in response to a request received from the virtual library control server 305. The robot control unit 321 notifies the drive control server 303 that the mounting of the physical volume PV is completed.

2-3-2. Drive Control Server (IDP)

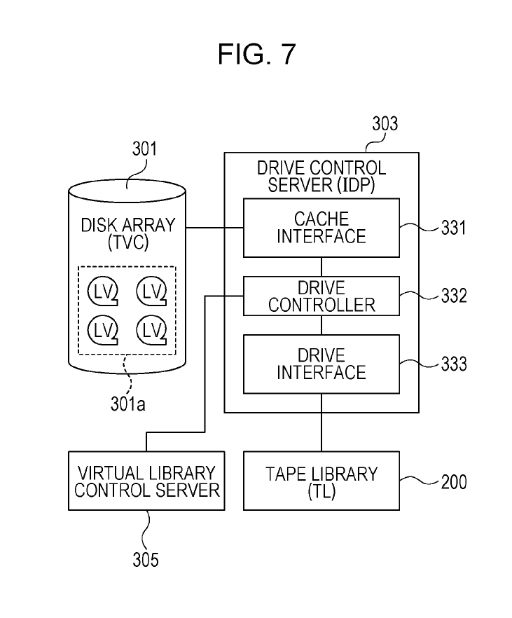

Next, the functions of the drive control server 303 will be further described with reference to FIG. 7. FIG. 7 is a diagram for illustrating the function included in a drive control server according to the second embodiment.

As illustrated in FIG. 7, the drive control server 303 includes a cache interface 331, a drive control unit 332, and a drive interface 333. It is possible to realize the functions of the drive control unit 332 using the above-described CPU 902.

The cache interface 331 is an interface for connecting the drive control server 303 and the disk array 301. The drive control unit 332 acquires the logical volume LV via the cache interface 331 in a case of acquiring the logical volume LV stored in the storage region 301a of the disk array 301.

The drive interface 333 is an interface for connecting the drive control server 303 and the physical drive 201 of the tape library 200. The drive control unit 332 stores the logical volume LV in the physical volume PV via the drive interface 333 in a case of storing the logical volume LV in the physical volume PV mounted to the physical drive 201.

The drive control unit 332 acquires the logical volume LV stored in the physical volume PV and stores the acquired logical volume LV in the storage region 301a of the disk array 301. The drive control unit 332 acquires the logical volume LV from the physical volume PV mounted to the physical drive 201 via the drive interface 333. The drive control unit 332 stores the logical volume LV in the storage region 301a of the disk array 301 via the cache interface 331.

The drive control unit 332 stores the logical volume LV stored in the storage region 301a of the disk array 301 in the physical volume PV in response to a request from the virtual library control server 305. The drive control unit 332 stores the logical volume LV stored in the physical volume PV in the storage region 301a of the disk array 301 in response to a request received from the virtual library control server 305.

2-3-3. Channel control server (ICP)

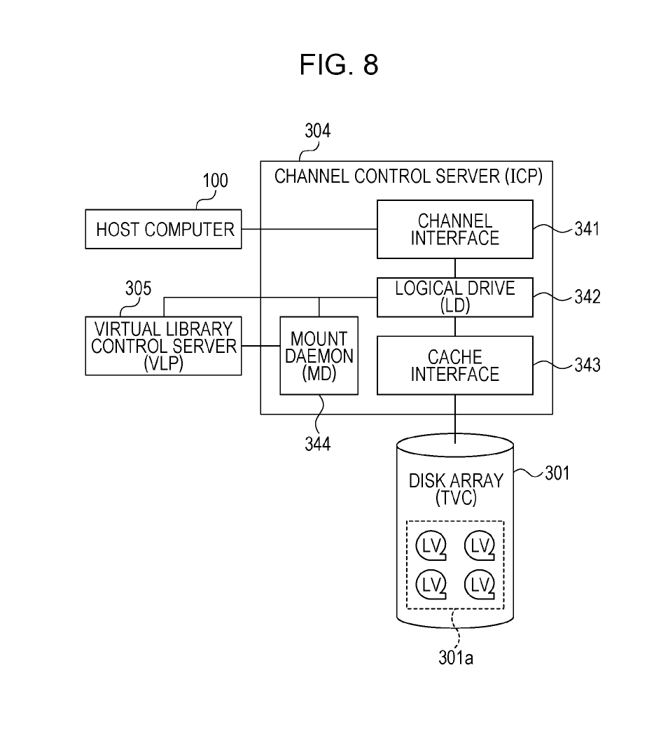

Next, the functions of the channel control server 304 will be further described with reference to FIG. 8. FIG. 8 is a diagram for illustrating the function included in a channel control server according to the second embodiment.

As illustrated in FIG. 8, the channel control server 304 includes a channel interface 341, a logical drive 342, a cache interface 343, and a mount daemon 344. The mount daemon 344 in the specification may be denoted as a mount daemon (MD). It is possible for the function of the mount daemon 344 to be realized using the above-described CPU 902 or the like. It is possible for the function of the logical drive 342 to be realized using the above-described CPU 902, RAM 906, storage unit 920 and the like.

The channel interface 341 is an interface for connecting the channel control server 304 and the channel 101 of the host computer 100. The logical drive 342 is a block representing a collection of one or a plurality of logical drives LD. The cache interface 343 is an interface for connecting the channel control server 304 and the storage region 301a of the disk array 301.

The mount daemon 344 acquires the logical volume LV that is the read processing target from the storage region 301a of the disk array 301 via the cache interface 343 and mounts the acquired logical volume LV to the logical drive 342. After the processing is completed with respect to the logical volume LV mounted to the logical drive 342, the mount daemon 344 unmounts the logical volume LV from the logical drive 342. The mount daemon 344 stores the unmounted logical volume LV in the storage region 301a of the disk array 301.

For example, the mount daemon 344 selects the logical volume LV in an unused state from the logical drive 342 and mounts the logical volume LV to the selected logical drive LD in response to a request received from virtual library control server 305. After the read processing or write processing is completed with respect to the logical volume LV mounted to the logical drive LD, the mount daemon 344 unmounts the logical volume LV from the logical drive LD.

2-3-4. Virtual Library Control Server (VLP)

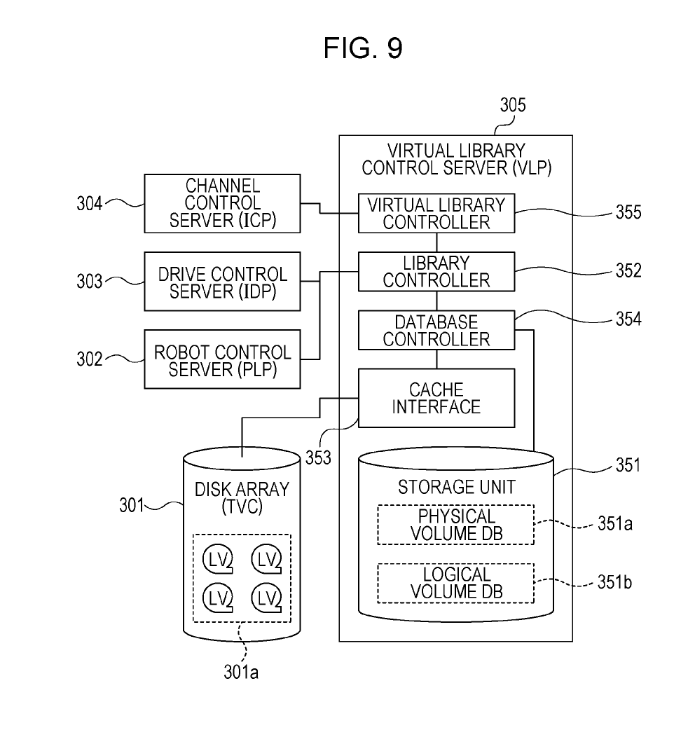

Next, the functions of the virtual library control server 305 will be further described with reference to FIG. 9. FIG. 9 is a diagram for illustrating the function included in the virtual library control server according to the second embodiment.

As illustrated in FIG. 9, the virtual library control server 305 includes a storage unit 351, a virtual library control unit 355, a library control unit 352, a database control unit 354, and a cache interface 353. It is possible for the functions of the virtual library control unit 355, the library control unit 352, and the database control unit 354 to be realized using the above-described CPU 902 and the like. It is possible for the functions of the storage unit 351 to be realized using the above-described RAM 906, storage unit 920 and the like.

Storage Unit 351

The storage unit 351 includes a physical volume database 351a and a logical volume database 351b.

Information of the physical volume PV managed by the tape library 200, information of the logical volume LV stored for each physical volume PV, or the like is stored in the physical volume database 351a. For example, a table that associates the identification information of the tape library 200 and identification information of the physical volume PV is included in the physical volume database 351a. A table that associates the identification information of the physical volume PV, identification information of the logical volume LV, and address information that indicates the storage position for each logical volume LV is included in the physical volume database 351a.

An LV state information table, an intra-LV file information table, an intra-LV file access statistics table, an intra-LV file compression information table, and a recompression processing job management table are included in the logical volume database 351b. A database that includes an ICP load information table is stored in the storage unit 351. Below, these tables will be described.

LV State Information Table

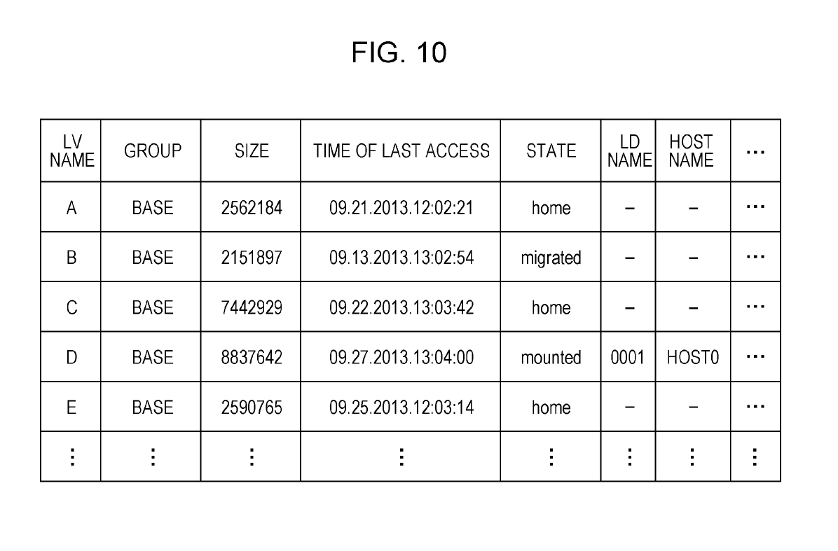

First, the LV state information table will be described with reference to FIG. 10. FIG. 10 is a diagram illustrating an example of the LV state information table according to the second embodiment.

As illustrated in FIG. 10, the LV state information table stores information corresponding to each of the items of the LV name, LV group (Group), size, last access time, state, LD name, and host name. Information such as the LV capacity (LV Size) or usage rate may also be stored in the LV state information table.

Information indicating the name (identification information) of the logical volume LV is stored in the LV name item. Information indicating the name (identification information) of the group to which the logical volume LV belongs is stored in the LV group name item. Information indicating the data size (for example, value of byte units) of the logical volume LV is stored in the size item. Information indicating the time of the last access from the host computer 100 to the logical volume LV is stored in the last access time item.

Information representing the state of the logical volume LV is stored in the state item. “home” representing an unused state and “scratch” representing an empty state of data are also included in the state of the logical volume LV. “migrated” representing a state of being saved from the storage region 301a of the disk array 301 to the physical volume PV and “mounted” representing a state of being mounted to the logical drive LD are also included in the state of the logical volume LV.

Information indicating the name (identification information) of the logical drive LD to which the logical volume LV is mounted is stored in the LD name item. Information indicating the name (identification information) of the host computer 100 on which the logical volume LV is used is stored in the host name item.

In the case of providing the LV capacity item, information (for example, value of bite units) indicating the capacity of the logical volume LV is stored in the item. In a case of providing the usage amount item, information indicating the proportion data amount stored with respect to the capacity of the LV is stored in the item.

Intra-LV File Information Table

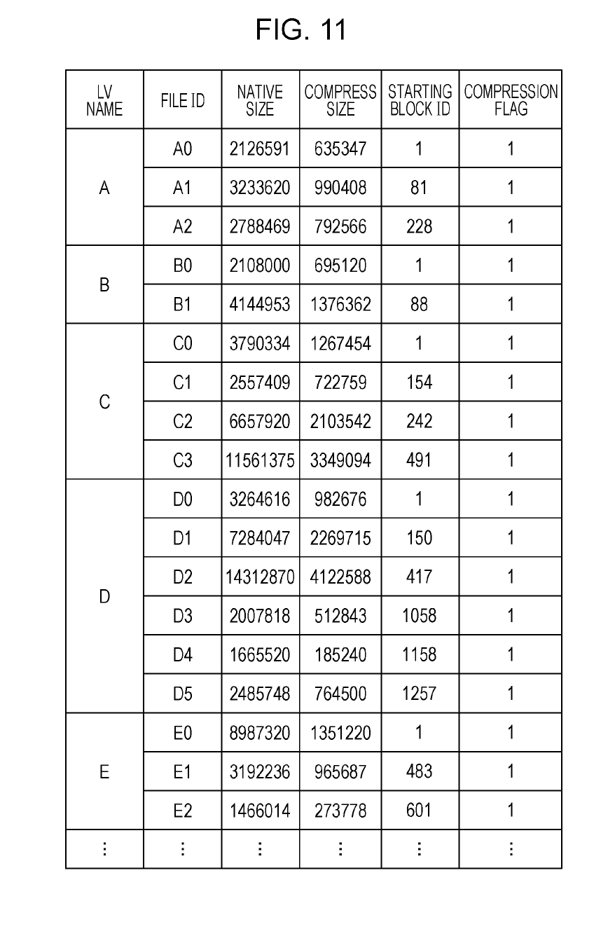

Next, the intra-LV file information table will be described with reference to FIG. 11. FIG. 11 is a diagram illustrating an example of an intra-LV file information table according to the second embodiment.

As illustrated in FIG. 11, the intra-LV file information table stores information corresponding to each of the items of the LV name, file ID, pre-compression data size (native size), the post-compression data size (compress size), the starting block ID, and the compression flag.

Information indicating the name (identification information) of the logical volume LV is stored in the LV name item. An identifier (ID) that identities the data file in the logical volume LV is stored in the file ID item. Information (for example, value of byte units) indicating the pre-compression data size is stored in the pre-compression data size item. Information (for example, value of byte units) indicating the post-compression data size is stored in the post-compression data size item.

The block ID indicating the starting block of the data file is stored in the starting block ID item. A flag for confirming whether or not the data file is compressed is stored in the compression flag item. For example, a flag “1” is stored in a case where the data file is compressed, and a flag “0” is stored in a case where the data file is not compressed. Here, although “0” and “1” are used, the flag may be arbitrarily expressed.

Intra-LV File Access Statistics Table

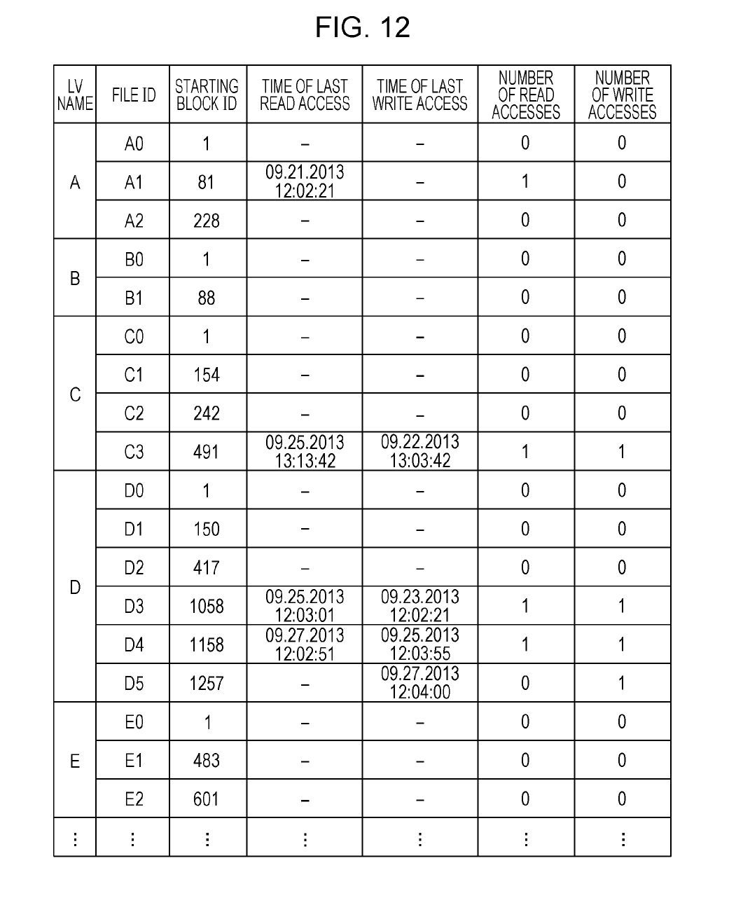

Next, the intra-LV file access statistics table will be described with reference to FIG. 12. FIG. 12 is a diagram illustrating an example of intra-LV file access statistics table according to the second embodiment.

As illustrated in FIG. 12, intra-LV file access statistics table stores information corresponding to each of the items of the LV name, file ID, starting block ID, last read access time, last write access time, number of read accesses, and number of write accesses.

Information indicating the name (identification information) of the logical volume LV is stored in the LV name item. The ID that identities the data file in the logical volume LV is stored in the file ID item. The block ID indicating the starting block of the data file is stored in the starting block ID item.

Information indicating the time of the last read access from the host computer 100 to the data file is stored in the last read access time item. Information indicating the time of the last write access from the host computer 100 to the data file is stored in the last write access time item.

Information indicating a count of the read access to data file performed by the host computer 100 in a specified time period is stored in the number of read accesses item. Information indicating a count of the write accesses to data file performed by the host computer 100 in a specified time period is stored in the number of write accesses item. The specified time period is set to the same time interval (for example, 1 week) as the scheduling period of jobs executed by the host computer 100.

Intra-LV File Compression Information Table

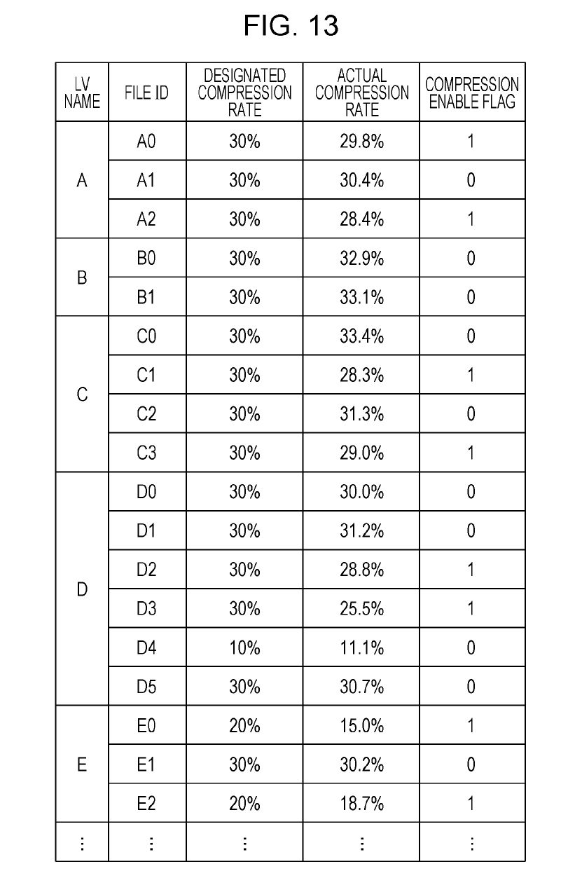

Next, the intra-LV file compression information table will be described with reference to FIG. 13. FIG. 13 is a diagram illustrating an example of an intra-LV file compression information table according to the second embodiment.

As illustrated in FIG. 13, the intra-LV file compression information table stores information corresponding to each of the items of the LV name, file ID, designated compression rate, actual compression rate, and compression enable flag.

Information indicating the name (identification information) of the logical volume LV is stored in the LV name item. The ID that identities the data file in the logical volume LV is stored in the file ID item. Information indicating the designated compression rate from the host computer 100 during writing of the file is stored in the designated compression rate item. Information indicating the actual compression rate of the data file stored in the disk array 301 is stored in the actual compression rate item.

The actual compression rate is expressed by the following formula (1). Here, in the following formula (1), a case in which the data size of the uncompressed header part (for example, the four File Header1, File Header2, End of File1, and End of File2) is 80 kbyte×4 is assumed. In other words, the compression rate of the data part that is the compression target is the actual compression rate. In a case in which the data size of the header part or the number is different, the value of “80×4” is changed.

Actual compression rate=(post-compression data size−80×4)/(pre-compression data size−80×4)×100 (1)

A flag for confirming whether or not further compression is enabled with respect to the data file is stored in the compression enable flag item. For example, in a case in which the actual compression rate is lower than the designated compression rate, the flag “1” indicating that further compression is enabled with respect to the data file is set. In a case in which the actual compression rate is higher than the designated compression rate, the flag “0” indicating that further compression is not enabled with respect to the data file is set. However, in a case in which the actual compression rate is lower than the lower limit value set in advance, the flag “0” is set. Here, although “0” and “1” are used, the flag may be arbitrarily expressed.

Recompression Processing Job Management Table

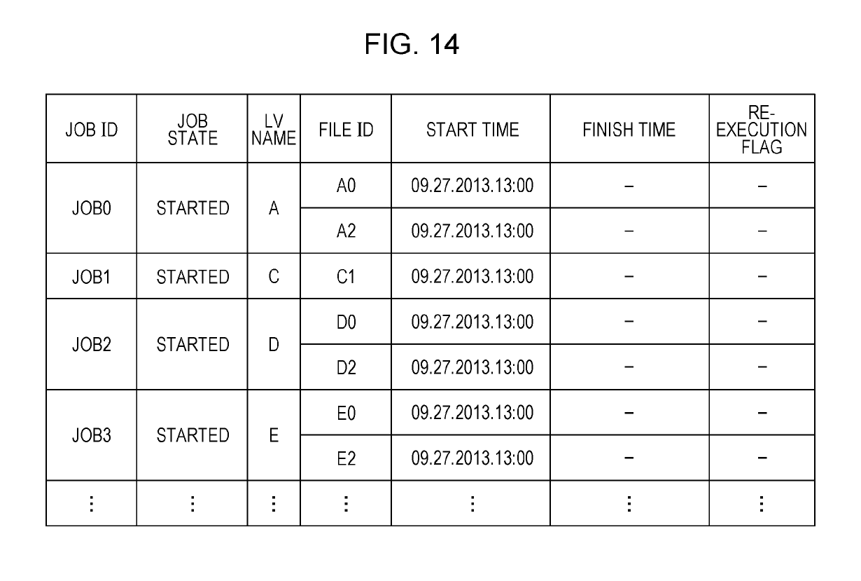

Next, the recompression processing job management table will be described with reference to FIG. 14. FIG. 14 is a diagram illustrating an example of a recompression processing job management table according to the second embodiment.

As illustrated in FIG. 14, the recompression processing job management table stores information corresponding to each item of the job ID, job state, LV name, start time, finish time, and the re-execution flag.

The ID that identifies the job of the recompression processing, described later, is stored in the job ID item. Information indicating the execution state for each logical volume LV pertaining to the job of the recompression processing is stored in the job state item. “Started” representing a job during execution, “suspended” representing a state where the job is suspended, and “completed” representing the completion of a job are included in the job execution state.

Information indicating the name (identification information) of the logical volume LV that is the job target is stored in the LV name item. The ID that identities the data file in the logical volume LV is stored in the file ID item. Information indicating the start time of a job is stored in the job start time item. Information indicating the finish time of a job is stored in the job finish time item.

A flag for confirming whether or not a job is a re-execution target when a state in which a job is executable is stored in the re-execution flag item. For example, a flag “1” is set in a data file that is a re-execution target when resuming execution of a job. On the other hand, a flag “0” is set in a data file that is not a re-execution target when resuming execution of a job. Here, although “0” and “1” are used, the flag may be arbitrarily expressed.

ICP Load Information Table

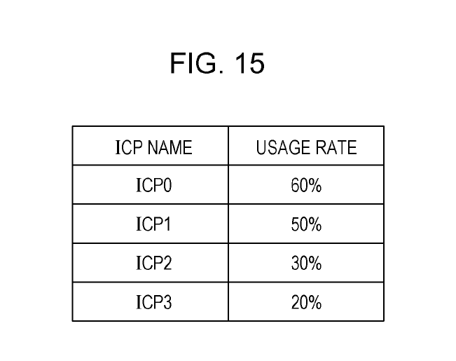

Next, the ICP load information table will be described with reference to FIG. 15. FIG. 15 is a diagram illustrating an example of an ICP load information table according to the second embodiment.

As illustrated in FIG. 15, information corresponding to the ICP name and the usage rage item is stored in the ICP load information table. Information indicating the name (identification information) of the channel control server 304 is stored in the ICP name item. Information indicating the load condition (for example, CPU usage rate or the like) of the channel control server 304 is stored in the usage rate item.

Library Control Unit 352

FIG. 9 is referred to again. The library control unit 352 controls the operation of the drive control server 303 and the robot control server 302. For example, the library control unit 352 controls the mounting and unmounting of the physical volume PV, the movement of the logical volume LV between the physical volume PV and the disk array 301, or the like.

Cache Interface 353

The cache interface 353 is an interface for connecting the virtual library control server 305 and the disk array 301. When the database control unit 354, described later, manages the state of the logical volume LV stored on the storage region 301a of the disk array 301, the database control unit 354 accesses the disk array 301 via the cache interface 353.

Database Control Unit 354

The database control unit 354 manages the above-described LV state information table (refer to FIG. 10), intra-LV file information table (refer to FIG. 11), intra-LV file access statistics table (refer to FIG. 12), and intra-LV file compression information table (refer to FIG. 13).

For example, in a case in which the logical volume LV is newly created, the database control unit 354 stores information of the logical volume LV in the LV state information table. In a case in which write access or read access occurs with respect to the logical volume LV, the database control unit 354 updates the information of the last access time for the logical volume LV. In a case in which the data size or state, the usage rate of the LV or the like is modified, the database control unit 354 mirrors the modification content in the LV state information table.

In a case in which the content of the LV state information table is modified, the database control unit 354 reflects the modification content in the intra-LV file information table. In a case in which a new logical volume LV is created, the database control unit 354 stores the information of the new logical volume LV in the intra-LV file information table. In a case of writing of a new data file to the logical volume LV, the database control unit 354 stores information of the written data file to the intra-LV file compression information table. In a case in which the data file of the logical volume LV is updated, the database control unit 354 reflects the update content in the intra-LV file compression information table.

In a case in which the content of the LV file information table is modified, the database control unit 354 reflects the modification content in the intra-LV file access statistics table. For example, in a case in which a new logical volume LV is created, the database control unit 354 stores the information of the new logical volume LV in the intra-LV file access statistics table. In a case of writing of a new data file to the logical volume LV, the database control unit 354 stores information of the written data file to the intra-LV file access statistics table.

In a case in which read access occurs with respect to the logical volume LV, the database control unit 354 updates the information of the last read access time for the logical volume LV. The database control unit 354 updates the information of the number of read accesses stored in the intra-LV file access statistics table. In a case in which write access occurs with respect to the logical volume LV, the database control unit 354 updates the information of the last write access time for the logical volume LV. The database control unit 354 updates the information of the number of write accesses stored in the intra-LV file access statistics table.

Here, updating of the intra-LV file access statistics table is further described.

As above, the database control unit 354 counts the number of read accesses and write accesses to the data file of the logical volume LV. However, the database control unit 354 counts the number of read accesses and write accesses that occur in a set time period (below, specified time period). The specified time period is set to match the scheduling period (for example, one week) of the job executed by the host computer 100. The database control unit 354 updates the intra-LV file access statistics table at a timing at which the read processing or write processing finishes.

The update process of the intra-LV file access statistics table is executed with the following procedure.

The database control unit 354 updates the information of the intra-LV file access statistics table so as to match the intra-LV file information table. Next, the database control unit 354 acquires the block ID designated by the positioning command that designates the position of the data that is the read processing or write processing target or the type of command executed from the logical drive LD. The positioning command is a command issued by the host computer 100 when requesting the execution of the read processing or write processing.

In a case in which the type of command acquired from the logical drive LD is a read command, the database control unit 354 compares the block ID acquired from the logical drive LD against the intra-LV file information table and specifies the file ID of the data file with read access. The database control unit 354 updates the last read access time and the number of read accesses of the intra-LV file access statistics table for the specified file ID.

Meanwhile, in a case in which the type of command acquired from the logical drive LD is a write command, the database control unit 354 compares the block ID acquired from the logical drive LD against the intra-LV file information table. The database control unit 354 specifies the file ID of the data file with write access. The database control unit 354 updates the last write access time and the number of write accesses of the intra-LV file access statistics table for the specified file ID.

The intra-LV file access statistics table is updated by the above method.

The database control unit 354 updates the intra-LV file compression information table at a timing at which the write processing and the recompression processing, described later, are finished. The database control unit 354 updates the information of the intra-LV file access statistics table so as to match the intra-LV file information table. Next, the database control unit 354 acquires the compression rate designated by the host computer 100 in the write processing or the compression rate designated in the recompression processing, described later, from the logical drive LD. The database control unit 354 updates the information of the designated compression rate stored in the intra-LV file compression information table with the compression rate acquired from the logical drive LD.

The database control unit 354 acquires the pre-compression data size and the post-compression data size from the intra-LV file information table. Next, the database control unit 354 calculates the actual compression rate based on the above formula (1). Next, the database control unit 354 updates the information of the actual compression rate stored in the intra-LV file compression information table with the actual compression rate calculated. The database control unit 354 compares the designated compression rate and the actual compression rate and determines whether or not further compression is enabled.

In a case in which the designated compression rate is higher than the actual compression rate, the database control unit 354 determines further compression to be enabled. On the other hand, in a case in which the designated compression rate is lower than the actual compression rate, the database control unit 354 determines further compression to not be enabled. In a case where it is determined that further compression is enabled, the database control unit 354 stores the compression enable flag “1” in the intra-LV file compression information table. On the other hand, in a case where it is determined that further compression is not enabled, the database control unit 354 stores the compression enable flag “0” in the intra-LV file compression information table.

However, with respect to a data file already compressed at the maximum compression rate set, even in a case in which the designated compression rate is lower than the actual compression rate, the compression enable flag is set to “0”.

The database control unit 354 performs management of the physical volume database 351a. The database control unit 354 is capable of accessing the recompression processing job management table and the ICP load information table. However, management of the recompression processing job management table and the ICP load information table is performed by the virtual library control unit 355 via the database control unit 354. Management of the physical volume database 351a is performed by the library control unit 352 via the database control unit 354.

Virtual Library Control Unit 355

The virtual library control unit 355 references the intra-LV file compression information table and executes the recompression processing on the data file with a compression enable flag of “1” as a target with the channel control server 304. The wording “recompression processing” indicates a process of again compressing a data file stored in the logical volume LV in a compressed state so as to have a different compression rate (for example, a further reduced compression rate). The recompression processing includes a step of creating a recompression processing job that is the execution unit of the recompression processing and a step of executing the recompression processing. Below, these steps will be described in order.

(A) Step of Creating Recompression Processing Job

The step of creating the recompression processing job will be described.

The virtual library control unit 355 begins the creation of the recompression processing job. For example, the virtual library control unit 355 automatically starts the recompression processing at the set start time when the last day of the period set is reached.

The set period is set to match the scheduling period (for example, one week) of the job executed by the host computer 100 similarly to the specified time period pertaining to the update of the intra-LV file access statistics table. Because there is the possibility of a high load on the channel control server 304 responsible for the compression processing, it is preferable that the start time of the recompression processing be set to a time slot with a low load (for example, 1:00 AM) on the virtual library 300.

The virtual library control unit 355 monitors the usage rate of the disk array 301 and, when the timing for starting the recompression processing is reached, determines whether or not the usage rate of the disk array 301 is higher than the set threshold. In a case where the usage rate of the disk array 301 is higher than the set threshold, the virtual library control unit 355 proceeds to the recompression processing. The usage rate represents the occupancy proportion of the used region in the storage region 301a of the disk array 301. Setting of the threshold used in the determination of the usage rate is set to a certain low value (for example, 50%) so that the recompression processing is executed before the logical volume LV is saved to the physical volume PV due to insufficient capacity of the disk array 301.

The virtual library control unit 355 determines one by one whether or not there is a state suitable for recompression for the logical volumes LV registered in the LV state information table. For example, the virtual library control unit 355 references the state of the logical volume LV stored in the LV state information table and determines whether there is a state other than “scratch, migrated” (below, may be referred to as state determination process).

The virtual library control unit 355 determines a logical volume LV in a state other than “scratch, migrated” to be in a state suitable to recompression. The virtual library control unit 355 determines a logical volume LV in a state other than “scratch, migrated” to be in a state unsuitable to recompression. The data file that is the compression target is not present in the logical volume LV in the scratch state. The logical volume LV in the migrated state is in a state in which the data that is the compression target is not stored on the disk array 301. Therefore, the logical volume LV in the scratch state and the logical volume LV in the migrated state are excluded from the targets of the recompression processing.

When the state determination process is executed for the LV state information table illustrated in FIG. 10, at least the A, C, D, and E logical volumes LV are determined to be in a state suitable to recompression.

Next, the virtual library control unit 355 references the information of the data file stored in the intra-LV file access statistics table for the logical volumes LV determined to be in a state suitable for recompression by the state determination process one by one. The virtual library control unit 355 determines one by one data file whether or not a data file for which the information is referenced is a data file suitable for recompression. For example, the virtual library control unit 355 determines whether the number of read accesses is a set number or less (for example, 0) (below, may be referred to as access determination process).

The virtual library control unit 355 determines a data file with a number of read accesses that is the set number or less to be a data file suitable for recompression. The virtual library control unit 355 determines a data file with a number of read accesses that exceeds the set number to be a data file unsuitable for recompression. However, even for a data file with a number of read accesses of the set number or less, in a case of a data file generated by the write processes within the specified time period, the virtual library control unit 355 determines the data file to be unsuitable to recompression processing.

The virtual library 300 is used in back up applications used by the host computer 100. In a case of being used in a back up application, the job executed by the host computer 100 is frequently scheduled in advance. The execution timing of the job is often periodic. Therefore, with respect of a data file with even a single read access from the host computer 100 within the specified time period, read access is predicted to occur again within the next specified time period.

When the access determination process is applied, it becomes difficult for recompression to be executed with respect to the data file for which read access is predicted. When in a state in which the compression rate is lower than the current status due to recompression, the decompression time of the data file executed during read access becomes longer and, although a risk of lowering the read performance arises, it is possible for such a risk to be reduced by applying the access determination process. Although there is concern of the load increasing on the channel control server 304 that executes the compression and decompression processes, along with the risk of the read performance lowering, such concerns are also mitigated by applying the access determination process.

For example, when the access determination process is executed for the intra-LV file access statistics table illustrated in FIG. 12, the data file with the file ID of A0 and A2 for the logical volume LV with the LV name of A is determined to be a data file suitable for recompression. The data files with the file IDs of C0, C1, and C2 for the logical volume LV with the LV name of C is determined to be a data file suitable for recompression. The data files with the file IDs of D0, D1, and D2 for the logical volume LV with the LV name of D are determined to be data files suitable for recompression. The data files with the file IDs of E0, E1, and E2 for the logical volume LV with the LV name of E are determined to be data files suitable for recompression.

The number of read accesses within the specified time period is employed as the determination criteria in the access determination process. The specified time period is related to the job execution period of the host computer 100 and is set to a sufficiently long period for the characteristics of the read access to be observed. Therefore, by performing determination of the number of read accesses within the specified time period as the criteria, decisions taking the characteristics of the read access into account become possible.

Next, the virtual library control unit 355 references the intra-LV file compression information table and determines one by one the validity of the recompression file determined to be suitable for recompression by the access determination process (below, may be referred to as enable conditions determination process). In a case where the compression enable flag corresponding to the target data file is “1”, the virtual library control unit 355 determines the data file to be a valid data file for recompression. On the other hand, in a case where the compression enable flag corresponding to the target data file is “0”, the virtual library control unit 355 determines the data file not to be a valid data file for recompression.

The data file able to be compressed through the designated compression rate (in other words, a data file in which “designated compression rate≧actual compression rate”) has the potential for the data size to be further reduced through recompression. On the other hand, a file unable to be compressed up to the designated compression rate (in other words, a data file in which “designated compression rate≦actual compression rate”) has little potential for the data size to be further reduced through recompression. Therefore, by applying the enable condition determination, it is possible to avoid the compression processing on a data file without prospects of a further compression effect and reduction of the processing load related to recompression and efficiency of the processing are realized.

For example, when the enable conditions determination process is executed for the intra-LV file compression information table illustrated in FIG. 13, the data files with the file IDs of A0 and A2 for the logical volume LV with the LV name of A are determined to be valid data files for recompression. The data file with the file ID of C1 for the logical volume LV with the LV name of C is determined to be a valid data file for recompression. The data files with the file IDs of D0 and D2 for the logical volume LV with the LV name of D are determined to be valid data files for recompression. The data files with the file IDs of E0 and E2 for the logical volume LV with the LV name of E are determined to be valid data files for recompression.

Next, the virtual library control unit 355 registers the information of the data file determined to be a valid data file for recompression in the recompression processing job management table. In a case where the recompression processing job management table is not present in the storage unit 351, the virtual library control unit 355 newly generates the recompression processing job management table. For example, in a case in which the determination process is executed for the tables illustrated in FIGS. 10 to 13, the recompression processing job management table becomes as illustrated in FIG. 14. The virtual library control unit 355, when the creation of the recompression processing job management table is completed, finishes the process of the step for creating the recompression processing job.

(B) Set of Executing the Recompression Processing

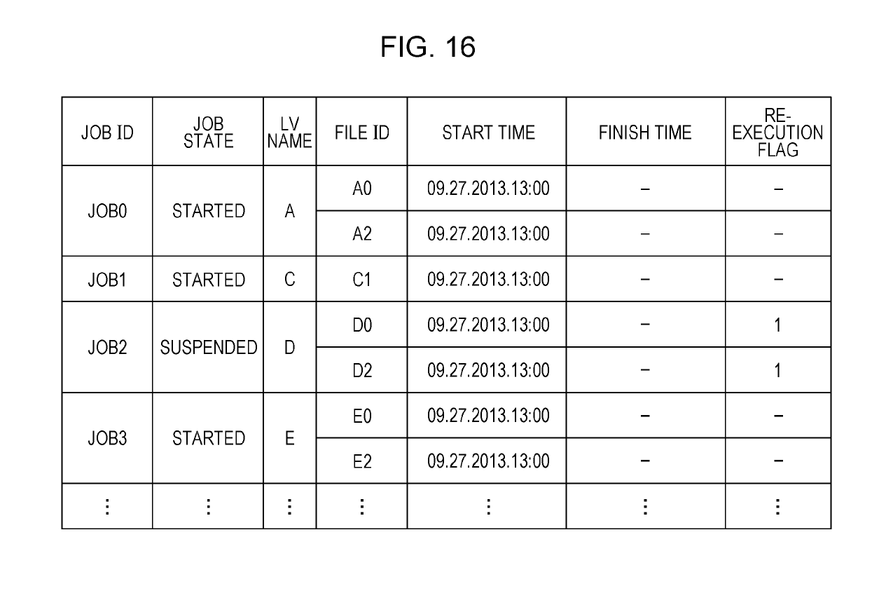

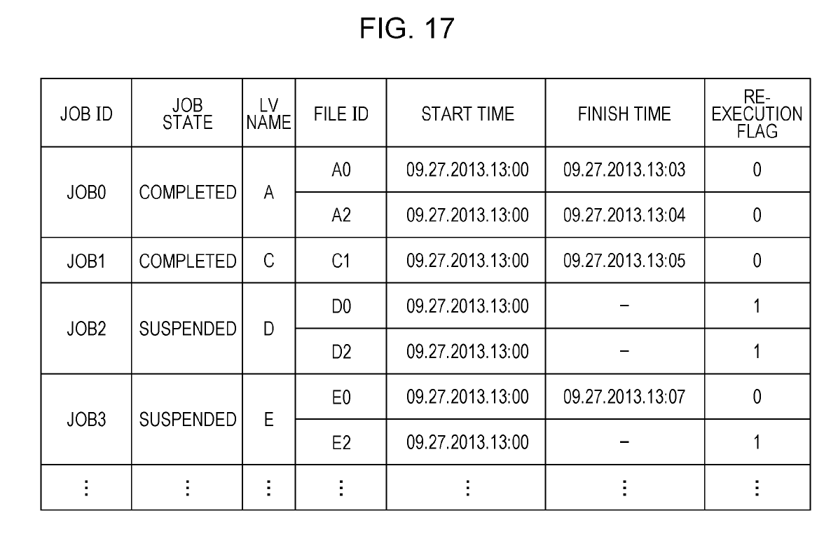

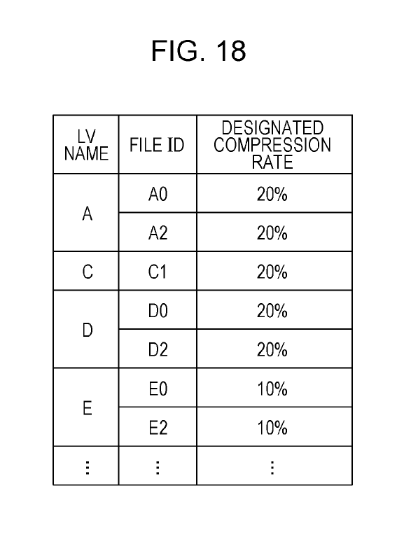

Next, the step of executing the recompression processing will be described. The following description refers to FIGS. 16 to 18. FIG. 16 is a diagram for illustrating updating of the recompression processing job management table (updating after unmount condition determination) according to the second embodiment. FIG. 17 is a diagram for illustrating the updating of the recompression processing job management table (case where main processing occurs during execution of recompression) according to the second embodiment. FIG. 18 is a diagram illustrating an example of notification information to the host computer according to the second embodiment.

When the step of creating the recompression processing job is finished, the virtual library control unit 355 begins execution of the recompression processing one by one for jobs registered in the recompression processing job management table at a time. For example, the virtual library control unit 355 extracts jobs for which the job state is not “completed” (jobs for which the re-execution flag is not “1”) from the jobs registered in the recompression processing job management table. The virtual library control unit 355 allocates the extracted jobs one by one to the channel control server 304.

At this time, the virtual library control unit 355 allocates the jobs in consideration of the load condition of the channel control server 304. The virtual library control unit 355 acquires the load information (for example, CPU usage rate) of the channel control server 304 responsible for the compression processing. The virtual library control unit 355 creates the ICP load information table (refer to FIG. 15) based on the acquired load information.

The virtual library control unit 355 references the ICP load information table and extracts the channel control server 304 with a load state in which the usage rate is lower than the set threshold (for example, 50%). In a case where extracting the channel control server 304 with the low load state is possible, the virtual library control unit 355 allocates the job to the extracted channel control server 304. In a case where it is possible to extract for one job a plurality of channel control servers 304 with a low load state, the virtual library control unit 355 allocates the job to the channel control server 304 with the lowest usage rate.

On the other hand, in a case where extracting the channel control server 304 with a low load is not possible, the virtual library control unit 355 repeatedly executes the creation of the ICP load information table and extraction of the channel control server 304 with a low load state. For example, the virtual library control unit 355 repeatedly executes the process at a set time interval (for example, every few seconds) until a channel control server 304 with a low load state appears.

When the recompression processing job is allocated to the channel control server 304 in a high load state, the load on the channel control server 304 further increases, and there is concern of influence, such as delays in the overall processing of the virtual library 300. For example, when the recompression processing job is allocated to the channel control server 304 during execution of processing related to main processing, there is concern of delays in the main processing arising. However, by allocating the recompression processing job to a channel control server 304 with a low load based on the ICP load information table, such concerns are mitigated.

In a case in which the ICP load information table illustrated in FIG. 15 is obtained, the job is allocated to the channel control server 304 with the ICP name of ICP3.

Next, the virtual library control unit 355 references the LV state information table and confirms the state of the logical volume LV corresponding to the job registered in the recompression processing job management table. The virtual library control unit 355 determines whether or not the logical volume LV that is the job target is in a state (home state) able to be mounted to the logical drive LD (below, may be referred to as “unmount condition determination process”).

In a case where the target logical volume LV is in a state of being mountable to the logical drive LD, the virtual library control unit 355 requests the channel control server 304 with a low load state extracted from the ICP load information table to mount the logical volume LV. On the other hand, in a case where the target logical volume LV is not in a state of being mountable to the logical drive LD, the virtual library control unit 355 sets the job state of the recompression processing job management table to “suspended” and sets the re-execution flag to “1”.

In a case where the state of the logical volume LV is the mounted state, the logical volume LV is used in main processing. Main processing is the processing with the highest priority degree from among the processes executed in the virtual library 300. By executing the unmount condition determination process, main processing is executed with priority, and the recompression processing is executed after main processing is completed.

For example, in a case in which the determination process is executed for the tables illustrated in FIGS. 10 to 14, the recompression processing job management table becomes as illustrated in FIG. 16. In this case, because the logical volume LV with the LV name of D is in the mounted state, the virtual library control unit 355 makes the state of the job JOB2 corresponding to the logical volume LV “suspended” and sets the re-execution flag of the data files D0 and D2 to “1”. The job JOB2 is executed afterwards by the virtual library control unit 355 based on the job state and the re-execution flag.

Next, the virtual library control unit 355 executes the recompression processing on the channel control server 304 one by one for jobs registered in the recompression processing job management table. At this time, the virtual library control unit 355 executes the recompression processing on the channel control server 304 by designating a compression rate a predetermined value (for example, 10%) lower than the designated compression rate disclosed in the intra-LV file compression information table.

However, in a case where the compression rate a predetermined value (for example, 10%) lower than the designated compression rate disclosed in the intra-LV file compression information table is lower than the minimum compression rate set (for example, 10%), the minimum compression rate is designated. The minimum compression rate is a compression rate uniformly set to the data files on the logical volume LV stored in the disk array 301.

As above, in the recompression processing according to the second embodiment, the compression rate is reduced a predetermined value at a time. The reason therefor is, when a data file is abruptly compressed to the minimum compression rate, the decompression time of the data file is lengthened in a case in which there is an unexpected read access that is not scheduled and a lowering of the access performance is caused. From the viewpoint of assessing the designated compression rate suitable for the target data file, the recompression processing is suitable.

When the recompression processing is completed, the virtual library control unit 355 updates the recompression processing job management table and the intra-LV file compression information table. For example, the virtual library control unit 355 sets the job state of the completed job to “completed” and registers the time the execution of the job is finished in the finish time item. The virtual library control unit 355 updates the designated compression rate in the intra-LV file compression information table with the compression rate designated during recompression. The virtual library control unit 355 updates the designated compression rate in the intra-LV file compression information table with the actual compression rate by recalculating the actual compression rate.

Here, a case in which the main processing is executed with respect to the logical volume LV during execution of the recompression processing is considered. In this case, the virtual library control unit 355 executes the recompression processing to completion with respect to the data file during execution of the recompression processing. The virtual library control unit 355 executes the main processing with priority without the recompression processing being executed even if the data file with scheduled execution of the recompression processing is on the same logical volume LV.

For example, a case in which the main processing is executed with respect to the logical volume LV with the LV name E partway through the recompression processing with respect to the data file E0 of the job JOB3 registered in the recompression processing job management table illustrated in FIG. 14 is considered. In this case, the virtual library control unit 355 executes the recompression processing of the data file E0 up to completion and suspends the recompression processing of the data file E2. The virtual library control unit 355 makes the job state of the job JOB3 “suspended” and prioritizes execution of the main processing once the re-execution flag of the data file E2 is set to “1”, as illustrated in FIG. 17.

A job with the job state “suspended” is thereafter re-executed.

Re-execution of the job will be described.

The virtual library control unit 355 references the job state in the recompression processing job management table and searches for the job that is a re-execution target for the recompression processing. In a case where there is no job with a job state of “suspended”, the virtual library control unit 355 determines that there is no job that is a target of re-execution. On the other hand, in a case where there is a job with a job state of “suspended”, the virtual library control unit 355 executes the recompression processing with respect to the data file with a re-execution flag of “1”.

In a case of the recompression processing job management table illustrated as an example in FIG. 17, the data files D0 and D2 included in the logical volume LV with the LV name of D become re-execution targets. The data file E2 included in the logical volume LV with the LV name of E also becomes a re-execution target. The virtual library control unit 355 executes the recompression processing with respect to the data files D0, D2, and E2 that are re-execution targets on the channel control server 304 with a low load state.

The virtual library control unit 355 again references the job state in the recompression processing job management table and, in a case where there is no job with a job state of “suspended”, the host computer 100 is notified of information of the logical volume LV on which the recompression processing is executed. For example, the virtual library control unit 355, as illustrated in FIG. 18, notifies the host computer 100 of the LV name of the logical volume LV on which the recompression processing is executed, the file ID of the data file on which the recompression processing is executed and the designated compression rate designated during recompression processing. At this time, the virtual library control unit 355 acquires the notification information from the intra-LV file compression information table.

When notification to the host computer 100 is completed, the virtual library control unit 355 finishes the recompression processing.

Above, the functions of the various servers included in the virtual library 300 were described.

2-4. Processing Flow

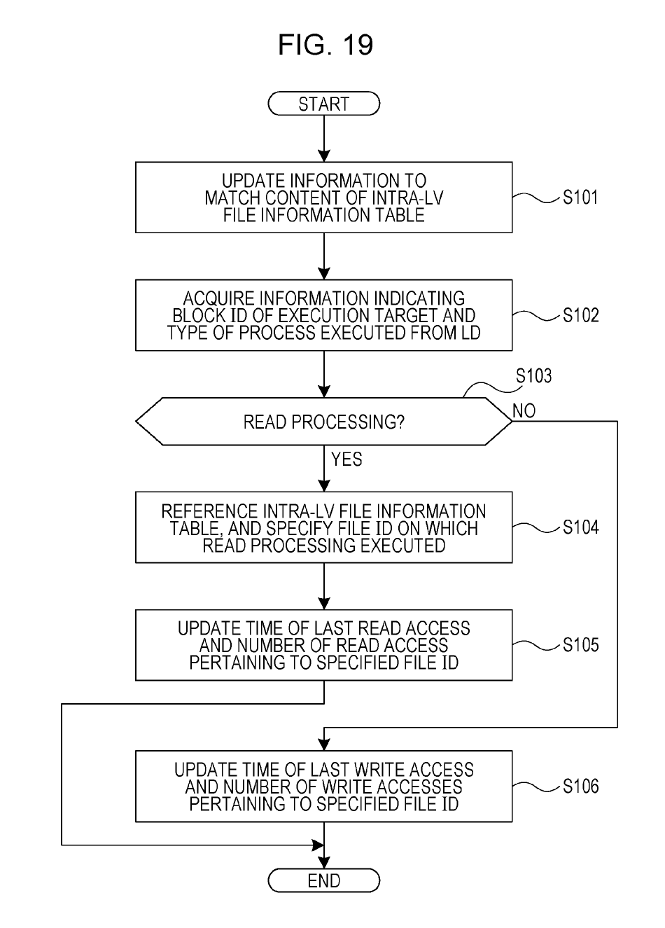

Next, the processing flow according to the update of the intra-LV file access statistics table, update of the intra-LV file compression information table, creation of the recompression processing job, and the execution of the recompression processing will be described in order with reference to FIGS. 19 to 23.

2-4-1. Updating of Intra-LV File Access Statistics Table

The processing flow according to the update of the intra-LV file access statistics table will be described with reference to FIG. 19. FIG. 19 is a flowchart illustrating update processing of the intra-LV file access statistics table according to the second embodiment.

(S101) The database control unit 354 updates the information of the intra-LV file access statistics table so as to match the content of the intra-LV file information table.

(S102) The database control unit 354 acquires information indicating the block ID of a data file that is an execution target of the read processing or the write processing and the type of processing executed.

(S103) The database control unit 354 determines whether or not the type of processing executed is the read processing. In a case where the type of processing executed is the read processing, the process proceeds to S104. On the other hand, in a case where the type of processing executed is the read processing, the process proceeds to S106.

(S104) The database control unit 354 references the intra-LV file information table and specifies the file ID of the data file on which the read processing is executed.

(S105) The database control unit 354 updates the last read access time pertaining to the specified file ID and the number of read accesses from among the information stored in the intra-LV file access statistics table. When the process in S105 is completed, the series of processes illustrated in FIG. 19 finishes.

(S106) The database control unit 354 updates the last write access time pertaining to the specified file ID and the number of write accesses from among the information stored in the intra-LV file access statistics table. When the process in S106 is completed, the series of processes illustrated in FIG. 19 finishes.

2-4-2. Update of Intra-LV File Information Table

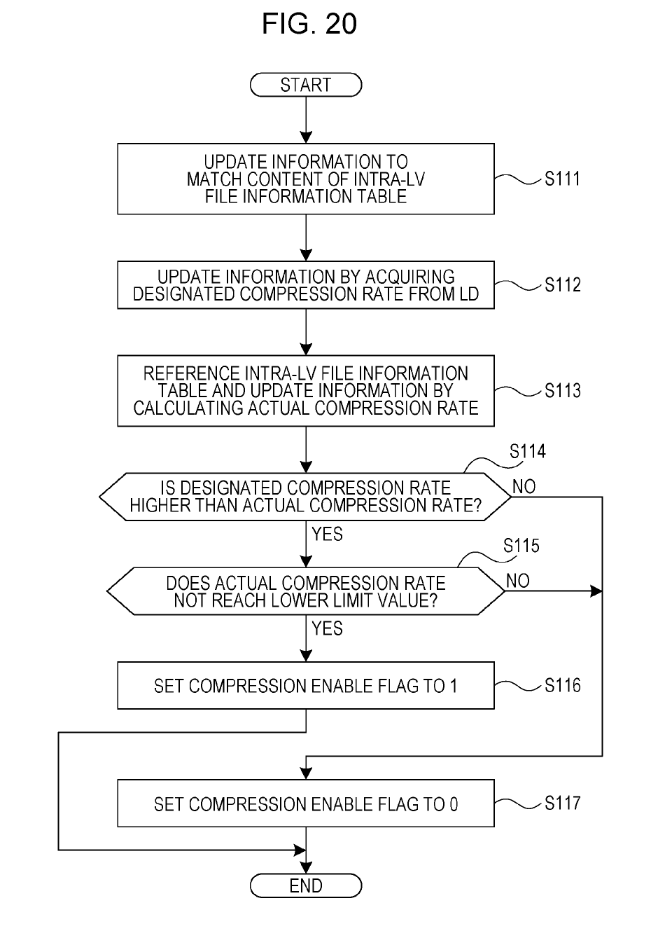

Next, the processing flow according to the update of the intra-LV file access statistics table will be described with reference to FIG. 20. FIG. 20 is a flowchart illustrating the update processing of the intra-LV file compression information table according to the second embodiment.

(S111) The database control unit 354 updates the information of the intra-LV file compression information table so as to match the content of the intra-LV file information table.

(S112) The database control unit 354 acquires the designated compression rate used during the write processing from the logical drive LD and updates the information on the designated compression rate included in the intra-LV file compression information table with the acquired designated compression rate.

(S113) The database control unit 354 references the intra-LV file information table and calculates the actual compression rate using the pre-compression data size and the post-compression data size. The database control unit 354 updates the information of the actual compression rate stored in the intra-LV file compression information table with the calculated actual compression.

(S114) The database control unit 354 determines whether or not the designated compression rate is higher than the actual compression rate. In a case where the designated compression rate is higher than the actual compression rate, the process proceeds to S115. On the other hand, in a case where the designated compression rate is higher than the actual compression rate, the process proceeds to S117.

(S115) The database control unit 354 determines that the actual compression rate does not reach the lower limit value (minimum compression rate). In a case where the actual compression rate reaches the lower limit value, the process proceeds to S117. On the other hand, in a case where the actual compression rate does not reach the lower limit value, the process proceeds to S116.

(S116) The database control unit 354 sets the compression enable flag corresponding to the target data file to “1” from the information included in the intra-LV file compression information table. When the process in S116 is completed, the series of processes illustrated in FIG. 20 finishes.

(S117) The database control unit 354 sets the compression enable flag corresponding to the target data file to “0” from the information included in the intra-LV file compression information table. When the process in S117 is completed, the series of processes illustrated in FIG. 20 finishes.

2-4-3. Creation of Recompression Processing Job

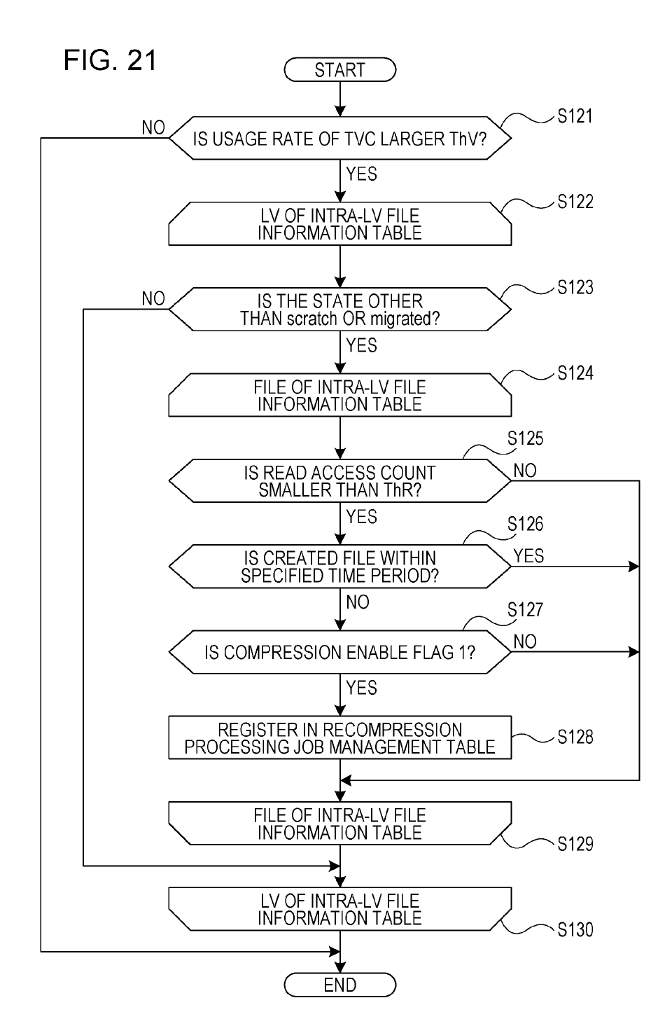

The processing flow according to the creation of the recompression processing job will be described with reference to FIG. 21. FIG. 21 is a flowchart illustrating a recompression job creation process according to the second embodiment.

(S121) The virtual library control unit 355 determines whether or not the usage rate of the disk array 301 is higher than the set threshold ThV. In a case where the usage rate of the disk array 301 is higher than the threshold ThV, the process proceeds to S122. On the other hand, in a case where the usage rate of the disk array 301 is not higher than the threshold ThV, the series of processes illustrated in FIG. 21 finishes.

(S122, S130) S122 is the start point of the processing loop that executes the processes that make all of the logical volumes LV registered in the intra-LV file information table between S122 and S130 for the logical volumes LV one by one. S130 is the finishing point of the processing loop.

(S123) The virtual library control unit 355 determines whether or not the target logical volume LV is in a state other than “scratch, migrated”. In a case in which the target logical volume LV is in a state other than “scratch, migrated”, the process proceeds to S124. On the other hand, in a case in which the target logical volume LV is not in a state other than “scratch, migrated”, the process proceeds to S130.

(S124, S129) S124 is the start point of a process loop that executes the processes that make all of the data files registered in the intra-LV file information table relating to the target logical volume LV between S124 and S129 one by one for the data files. S129 is the finishing point of the processing loop.

(S125) The virtual library control unit 355 determines whether or not the read access count for the target data file is lower than the set threshold ThR. In a case where the read access count is lower than the set threshold ThR, the process proceeds to S126. On the other hand, in a case where the read access count is lower than the set threshold ThR, the process proceeds to S129.

(S126) The virtual library control unit 355 determines whether or not the target data file is a data file created within the specified time period. In a case where the target data file is a data file created within the specified time period, the process proceeds to S129. On the other hand, in a case where the target data file is not a data file created within the specified time period, the process proceeds to S127.

(S127) The virtual library control unit 355 determines whether or not the compression enable flag corresponding to the target data file is “1”. In a case where the compression enable flag corresponding to the target data file is “1”, the process proceeds to S128. On the other hand, in a case where the compression enable flag corresponding to the target data file is not “1” (case where the compression enable flag is “0”), the process proceeds to S129.

(S128) The virtual library control unit 355 registers the target data file in the recompression processing job management table. When the process of S128 is completed, the process proceeds to S129 and the processes from S124 onwards are repeatedly executed for a different data file by the processing loop. Even in a case in which the process arrives at S130, the processes from S122 onwards are repeatedly executed for a different logical volume LV by the processing loop.

2-4-4. Execution of Recompression Processing

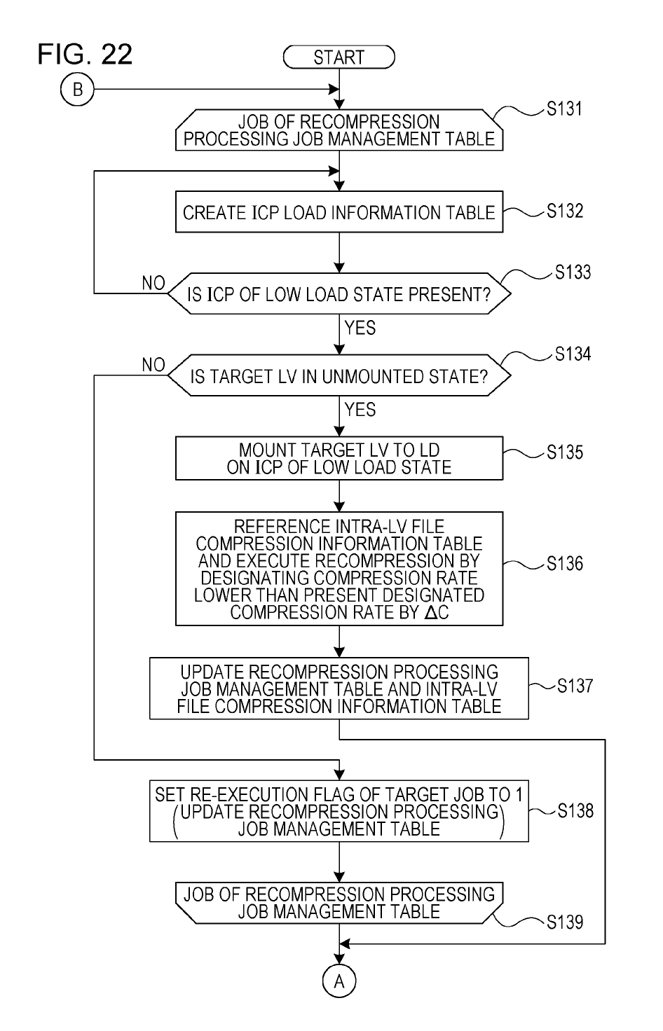

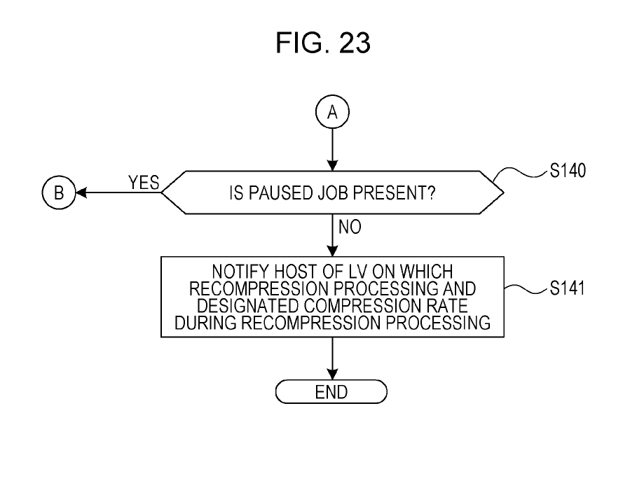

The processing flow according to the execution of the recompression processing will be described with reference to FIGS. 22 and 23. FIG. 22 is a first flowchart illustrating the flow of recompression processing according to the second embodiment. FIG. 23 is a second flowchart illustrating the flow of recompression processing according to the second embodiment.

(S131, S139) S131 is the starting point of a processing loop that executes the processes that make all of the jobs registered in the recompression processing job management table the target between S131 and 139 one by one for the jobs. S139 is the finishing point of the processing loop.

(S132) The virtual library control unit 355 acquires the load information of the channel control server 304 and creates the ICP load information table based on the acquired load information.

(S133) The virtual library control unit 355 references the ICP load information table and determines whether or not a channel control server 304 with a low load state is present. In a case where a channel control server 304 with a low load state is present, the process proceeds to S134. On the other hand, in a case where a channel control server 304 with a low load state is not present, the process proceeds to S132.

(S134) The virtual library control unit 355 determines whether or not the logical volume LV that is a job target is in an unmounted state (home state). In a case in which the logical volume LV that is the job target is in the unmounted state (home state), the process proceeds to S135. On the other hand, in a case in which the logical volume LV that is the job target is not in the unmounted state (home state), the process proceeds to S138.

(S135) The virtual library control unit 355 mounts the logical volume LV that is the job target to the logical drive LD on the channel control server 304 with a low load state.

(S136) The virtual library control unit 355 references the intra-LV file compression information table and executes recompression on the channel control server 304 by designating a compression rate a predetermined value ΔC (for example, 10%) lower than the current designated compression rate.

(S137) The virtual library control unit 355 updates the recompression processing job management table and the intra-LV file compression information table. For example, the virtual library control unit 355 updates the information such as the job state and finish time of the target job. The virtual library control unit 355 updates the value of the designated compression rate with the compression rate designated during execution of the recompression. When the process of S137 is completed, the process proceeds to S140 in FIG. 23.

(S138) The virtual library control unit 355 updates the recompression processing job management table. At this time, the virtual library control unit 355 sets the re-execution flag of the target job to “1”. The virtual library control unit 355 sets the job state of the target job to “paused”. When the process of S138 is completed, the process proceeds to S139 and the processes from S131 onwards are repeatedly executed for a different job by the processing loop.

(S140) The virtual library control unit 355 references the recompression processing job management table and determines whether or not a job with a job state of “paused” is present. In a case where a job with a job state of “paused” is present, the process proceeds to S131. On the other hand, in a case where a job with a job state of “paused” is not present, the process proceeds to S141.

(S141) The virtual library control unit 355 notifies the host computer 100 of the information pertaining to the logical volume LV on which the recompression processing is executed and the designated compression rate during recompression. When the process in S141 is completed, the series of processes illustrated in FIGS. 22 and 23 finishes.

By executing the recompression process according to the second embodiment, the compression rate of data files with a low frequency of read access is gradually reduced. In a case in which the characteristics of the read access do not change, it is possible for the database to be effectively utilized while giving consideration to a lowering of the access performance through recompression in which the compression rate is gradually lowered.

However, a condition in which the characteristics of the read access suddenly change at an advanced stage of compression and the frequency of read access increases. When the read access frequently occurs with respect to a highly compressed data file, a long time is taken in the compression and decompression processes executed on each read access and there is concern of the access performance being lowered. In the third embodiment, a method is proposed for recompressing the data file so that the compression rate becomes higher than the current compression rate with respect to a data file with more read accesses than a set read access count.

Here, the recompression method that increases the compression rate may be referred to as a “compression relaxation”. The main difference between the virtual library system according to the third embodiment and the virtual library system according to the second embodiment illustrated in FIG. 2 is the function of the virtual library control server 305. Below, the processing flow according to the function of the virtual library control server 305 according to the third embodiment, updating of the intra-LV file compression information table, creation of the recompression processing job, and the execution of the recompression processing will be described in order.

3-1. Function of Virtual Library Control Server (VLP)

The function of the virtual library control server 305 according to the third embodiment is illustrated in a block diagram in FIG. 9 similarly to the virtual library control server 305 according to the second embodiment. However, the information stored in the storage unit 351 and the functions of the database control unit 354 and the virtual library control unit 355 have points of difference with the second embodiment. Below, description is provided centering on these points of difference.

Storage Unit 351

First, the storage unit 351 will be described.

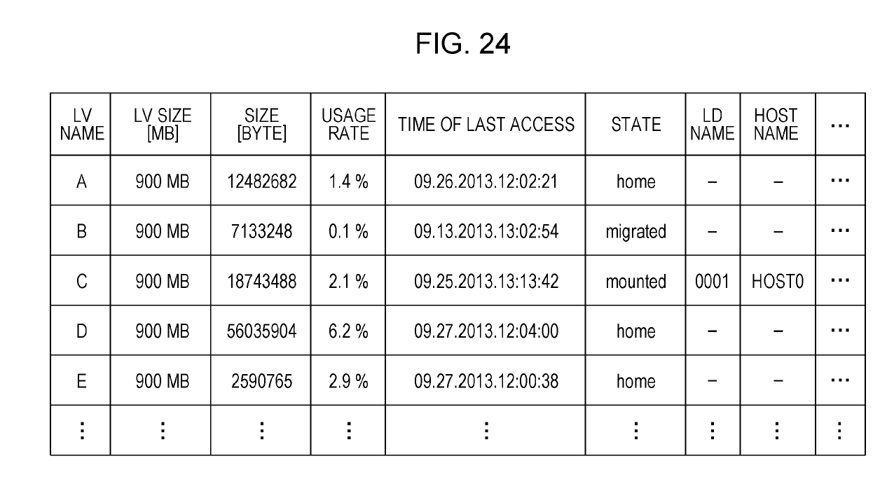

An LV state information table, an intra-LV file information table, an intra-LV file access statistics table, an intra-LV file compression information table (compression relaxation), and a recompression processing job management table (compression relaxation) are included in the logical volume database 351b stored in the storage unit 351. The database that includes the ICP load information table and the priority degree information are stored in the storage unit 351. Below, the tables and information will be described with reference to FIGS. 24 to 29.

LV State Information Table

FIG. 24 is a diagram illustrating an example of an LV state information table according to the third embodiment. As illustrated in FIG. 24, the LV state information table according to the third embodiment has the same structure as the LV state information table illustrated as an example in FIG. 10. However, in FIG. 24, the item names are arranged and denoted for ease of the description of the compression relaxation according to the third embodiment.

As illustrated in FIG. 24, the LV state information table stores information corresponding to each of the items of the LV name, LV capacity (LV Size), size (Size), usage rate, last access time, state, LD name, and host name. Information such as the LV group (Group) may be stored similarly to FIG. 10 in the LV state information table.

Intra-LV File Information Table and Intra-LV File Access Statistics Table

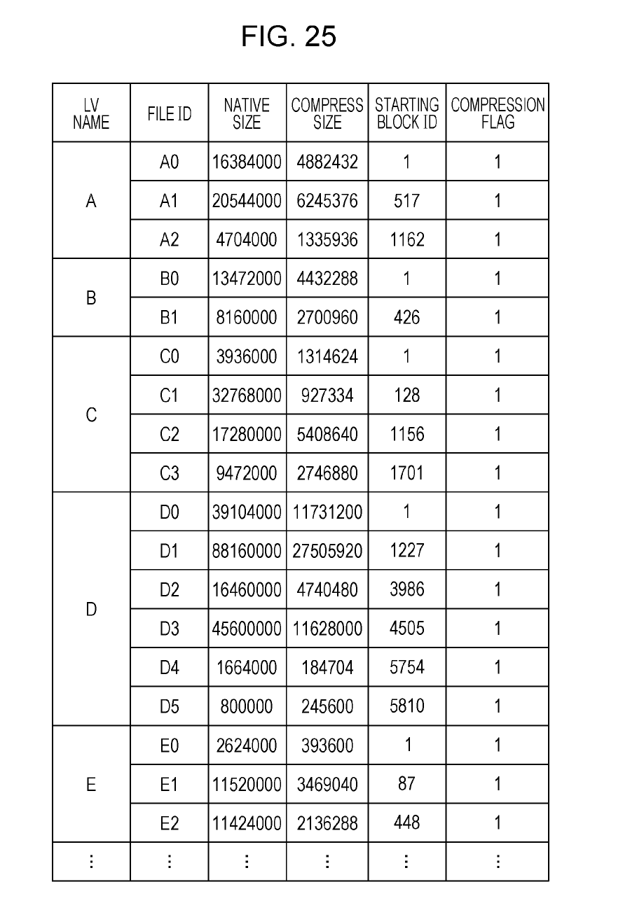

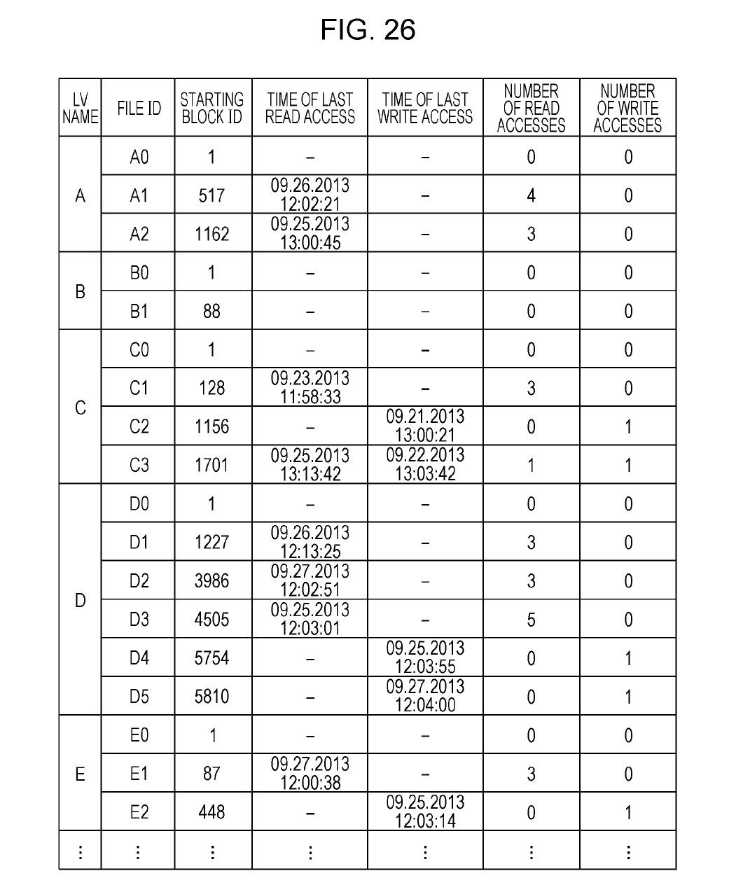

FIG. 25 is a diagram illustrating an example of an intra-LV file information table according to the third embodiment. FIG. 26 is a diagram illustrating an example of an intra-LV file access statistics table according to the third embodiment. As illustrated in FIG. 25, the intra-LV file information table according to the third embodiment has the same structure as the intra-LV file information table illustrated as an example in FIG. 11. As illustrated in FIG. 26 the intra-LV file access statistics table according to the third embodiment has the same structure as the intra-LV file access statistics table illustrated as an example in FIG. 12.

Intra-LV File Compression Information Table (Compression Relaxation)

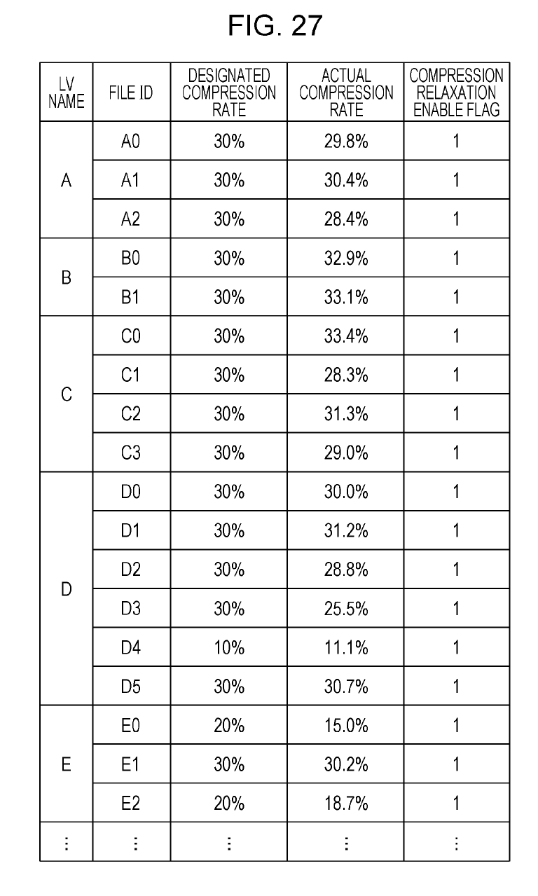

FIG. 27 is a diagram illustrating an example of an intra-LV file compression information table according to the third embodiment. As illustrated in FIG. 27, the intra-LV file compression information table according to the third embodiment stores information corresponding to each of the items of the LV name, file ID, designated compression rate, actual compression rate, and compression relaxation enable flag. A difference with the intra-LV file information table illustrated by example in FIG. 13 is the point that the intra-LV file compression information table illustrated by example in FIG. 27 includes a compression relaxation enable flag item.

The intra-LV file compression information table illustrated by example in FIG. 13 includes a compression enable flag referenced when determining the validity of recompression in which the compression rate is reduced. On the other hand, the intra-LV file compression information table illustrated by example in FIG. 27 includes a compression relaxation enable flag referenced when determining the validity of recompression (compression relaxation) in which the compression rate is increased. Below, the intra-LV file compression information table according to the third embodiment may be denoted as the intra-LV file compression information table (compression relaxation).

Recompression Processing Job Management Table (Compression Relaxation) and ICP Load Information Table

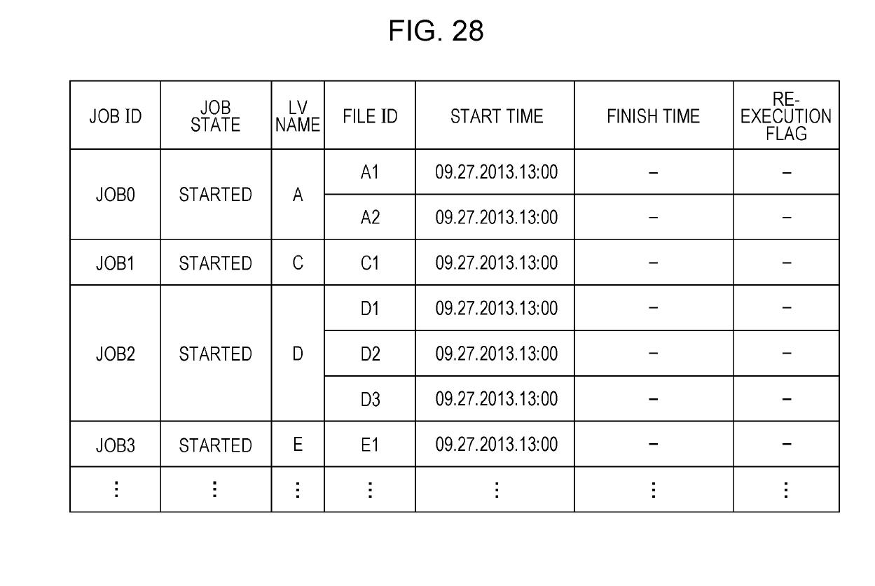

FIG. 28 is a diagram illustrating an example of a recompression processing job management table according to the third embodiment. As illustrated in FIG. 28, the recompression processing job management table according to the third embodiment has the same structure as the recompression processing job management table illustrated by example in FIG. 14. However, the recompression processing job management table according to the third embodiment is a table that manages the jobs of recompression processing according to the compression relaxation. Below, the recompression processing job management table according to the third embodiment may be denoted as recompression processing job management table (compression relaxation). The ICP load information table according to the third embodiment has the same structure as the ICP load information table illustrated by example in FIG. 15.

Priority Degree Information

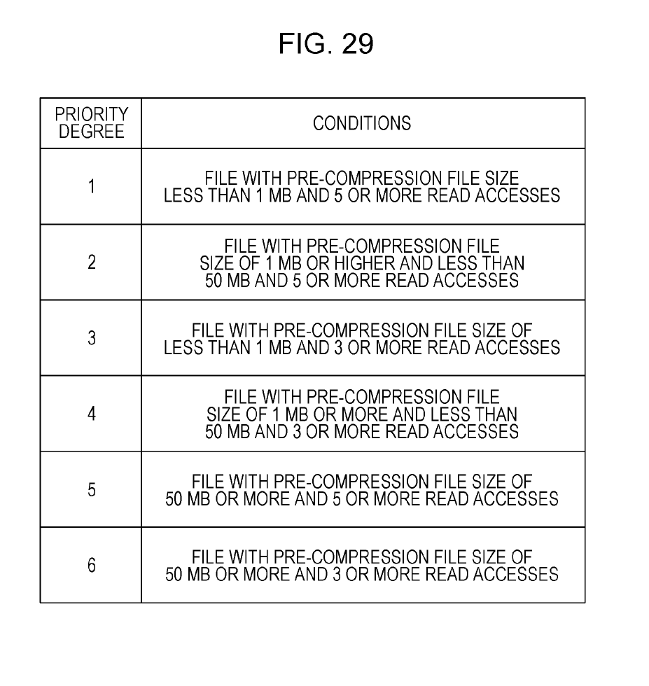

FIG. 29 is a diagram illustrating an example of the priority information according to the third embodiment. The priority degree information illustrate by example in FIG. 29 is information indicating the set conditions of the priority degree set for each data file.

According to the setting conditions illustrated by example in FIG. 29, a priority degree of “1” is set to a data file with a pre-compression file size of less than 1 MB and a five or more read accesses. A priority degree of “2” is set to a data file with a pre-compression file size of 1 MB or more and less than 50 MB and five or more read accesses.

A priority degree of “3” is set to a data file with a pre-compression file size of less than 1 MB and three or more read accesses. A priority degree of “4” is set to a data file with a pre-compression file size of 1 MB or more and less than 50 MB and three or more read accesses. A priority degree of “5” is set to a data file with a pre-compression file size of 50 MB or more and five or more read accesses. A priority degree of “6” is set to a data file with a pre-compression file size of 50 MB or more and three or more read accesses.

In this way, in the third embodiment, priority degree information indicating the setting method of the priority degree according to the pre-compression file size and the read access count is stored in the storage unit 351. These priority degrees are used when sorting the recompression processing job management table.

Database Control Unit 354

Next, the database control unit 354 will be described.

The database control unit 354 according to the third embodiment further includes the function of setting the compression relaxation enable flag (refer to FIG. 27) included in the intra-LV file compression information table.

The database control unit 354 determines whether or not the file size when the data file is uncompressed is the set size (for example, 100 MB) or less for the data file that is a setting target of the compression relaxation enable flag. In a case in which the file size when uncompressed exceeds the set size, the database control unit 354 sets the compression relaxation enable flag to “0”.

Meanwhile, in a case when the file size when uncompressed is the set size or less, the database control unit 354 determines whether or not the actual compression rate of the data file is 0%. In a case where the actual compression rate is 0%, the database control unit 354 sets the compression relaxation enable flag to “0”. Conversely, in a case where the actual compression rate is not 0%, the database control unit 354 sets the compression relaxation enable flag to “1”.

The database control unit 354 reflects the setting of the compression relaxation enable flag in the intra-LV file compression information table. In this way, the database control unit 354 according to the third embodiment sets the compression relaxation enable flag based on the file size of the data file when uncompressed and the actual compression rate.

Virtual Library Control Unit 355

Next, the virtual library control unit 355 will be described.

The virtual library control unit 355 references the intra-LV file compression information table and executes the recompression processing on the data file with a compression relaxation enable flag of “1” as a target with the channel control server 304. The recompression processing includes a step of creating a recompression processing job that is the execution unit of the recompression processing and a step of executing the recompression processing. Below, relating to the recompression processing according to the compression relaxation, these steps will be described in order.

(A) Step of Creating Recompression Processing Job

The step of creating the recompression processing job will be described.

The virtual library control unit 355 begins the creation of the recompression processing job. For example, the virtual library control unit 355 automatically starts the recompression processing at the set start time when the last day of the period set is reached. The set time period is set to match the scheduling period (for example, one week) of the job executed by the host computer 100. It is preferable that the start time of the recompression processing be set to a time slot (for example, 1:00 AM) with a low load on the virtual library 300.

The virtual library control unit 355 monitors the usage rate of the disk array 301 and, when the timing for starting the recompression processing is reached, determines whether or not the usage rate of the disk array 301 is higher than the set threshold. In a case where the usage rate of the disk array 301 is higher than the set threshold, the virtual library control unit 355 proceeds to the recompression processing.

The usage rate represents the occupancy proportion of the used region in the storage region 301a of the disk array 301. Setting of the threshold used in the determination of the usage rate is set to a certain low value (for example, 60%) so as to be performed in a condition with a surplus in empty capacity so that there is no falling to insufficient capacity of the disk array 301 caused by the compression relaxation.

The virtual library control unit 355 determines whether or not there is a suitable state for recompression one by one for the logical volumes LV registered in the LV state information table. For example, the virtual library control unit 355 references the state of the logical volume LV stored in the LV state information table and determines whether there is a state other than “scratch, migrated” (state determination process).

The virtual library control unit 355 determines a logical volume LV in a state other than “scratch, migrated” to be in a state suitable to recompression. The virtual library control unit 355 determines a logical volume LV in a state other than “scratch, migrated” to be in a state unsuitable to recompression. For example, when the state determination process is executed for the LV state information table illustrated in FIG. 24, at least the A, C, D, and E logical volumes LV are determined to be in a state suitable to recompression.

Next, the virtual library control unit 355 determines whether or not the usage rate (for example, 60%) of the logical volume LV is the set threshold or below one by one for the logical volumes LV determined to be in a state suitable for recompression by the state determination process. For example, when compression relaxation is performed with respect to a logical volume LV with a high usage rage, the capacity of the logical volume LV is compressed and there is a possibility of write access to the logical volume LV being suddenly restricted. Therefore, the logical volume LV in which the usage rate exceeds the set threshold is determined to not be suitable for recompression.

For example, when the LV state information table is referenced illustrated in FIG. 24, at least the A, C, D, and E logical volumes LV are determined to be in a state suitable to recompression among the logical volumes LV determined to be in a state suitable for recompression by the state determination process.

Next, the virtual library control unit 355 references the information of the intra-LV file information table for the logical volume LV determined to be in a state suitable for recompression through the determination of the usage rate. The virtual library control unit 355 determines whether or not the number of read accesses is a set number or more (for example, three) one by one for the data files for which the information is reference (access determination process).

A data file in which the number of read accesses is the set number or more is determined to be a data file suitable for recompression according to compression relaxation. On the other hand, a data file in which the number of read accesses is less than the set number determined to be a data file unsuitable for recompression according to compression relaxation.

Because the compression and decompression time during read access is shortened due to the compression relaxation, the effect due to compression relaxation becomes more remarkable the more frequent the read access to the data file. Therefore, as above, a data file with a high read access frequency is determined to be a data file suitable for recompression according to compression relaxation.

However, even for a data file with a number of read accesses exceeding set number, in a case of a data file created by the write processes within the specified time period, the virtual library control unit 355 determines the file to be unsuitable to recompression processing.

For example, when the access determination process is executed for the intra-LV file access statistics table illustrated in FIG. 26, the data files with the file ID of A1 and A2 for the logical volume LV with the LV name of A are determined to be data files suitable for recompression. The data file with the file ID of C1 for the logical volume LV with the LV name of C is determined to be a data file suitable for recompression.

The data files with the file IDs of D1, D2, and D3 for the logical volume LV with the LV name of D are determined to be a data file suitable for recompression. The data file with the file ID of E1 for the logical volume LV with the LV name of E is determined to be a data file suitable for recompression.

Next, the virtual library control unit 355 references the intra-LV file compression information table and determines the validity of recompression one by one for the files determined to be suitable for recompression by the access determination process (enable conditions determination process).

In a case where the compression relaxation enable flag corresponding to the target data file is “1”, the virtual library control unit 355 determines the data file to be a valid data file for recompression. On the other hand, in a case where the compression relaxation enable flag corresponding to the target data file is “0”, the virtual library control unit 355 determines the data file not to be a valid data file for recompression.

When compression relaxation is performed with respect to a data file for which the data size when uncompressed is too large, there is a possibility of the capacity of the logical volume LV on which the data file is stored being rapidly compressed. The compression rate may not be lowered lower than the current status for a data file in an uncompressed state (compression rate of 0%). Therefore, a data file with a compression relaxation enable flag of “0”, is determined to be a data file not suitable for recompression.

For example, when the enable conditions determination process is executed for the intra-LV file access statistics table illustrated in FIG. 27, the data files with the file IDs of A1 and A2 for the logical volume LV with the LV name of A are determined to be valid data files for recompression with regard to compression relaxation. The data file with the file ID of C1 for the logical volume LV with the LV name of C is determined to be a valid data file for recompression with regard to compression relaxation.

The data files with the file IDs of D1, D2, and D3 for the logical volume LV with the LV name of D are determined to be valid data files for recompression. The data file with the file ID of E1 for the logical volume LV with the LV name of E is determined to be a valid data file for recompression with regard to compression relaxation.

Next, the virtual library control unit 355 registers information of the data file determined to be a valid data file for recompression for compression relaxation in the recompression processing job management table (compression relaxation) that manages the recompression processing jobs according to the compression relaxation. In a case where the recompression processing job management table (compression relaxation) is not present in the storage unit 351, the virtual library control unit 355 newly generates the recompression processing job management table (compression relaxation).

For example, in a case in which the determination process is executed for the tables illustrated in FIGS. 24 to 27, the recompression processing job management table (compression relaxation) becomes as illustrated in FIG. 28. The virtual library control unit 355, when the creation of the recompression processing job management table (compression relaxation) is completed, finishes the process of the step for creating the recompression processing job.

(B) Set of Executing the Recompression Processing

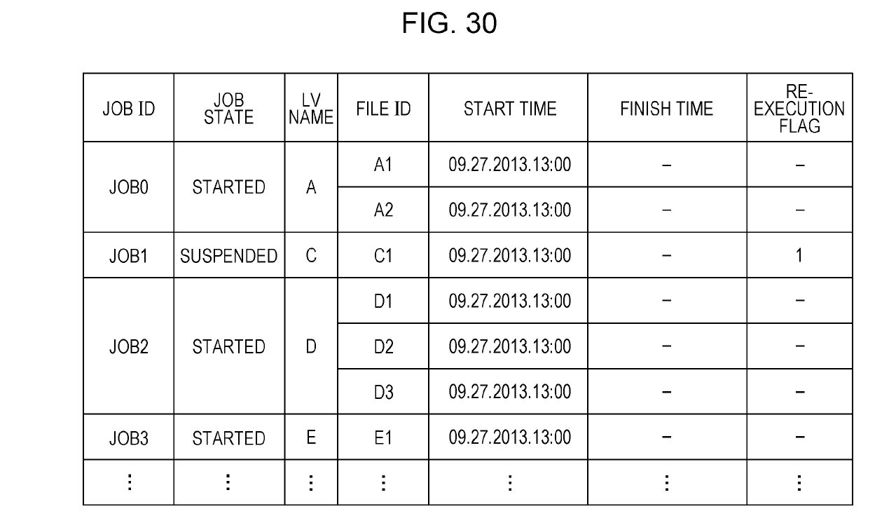

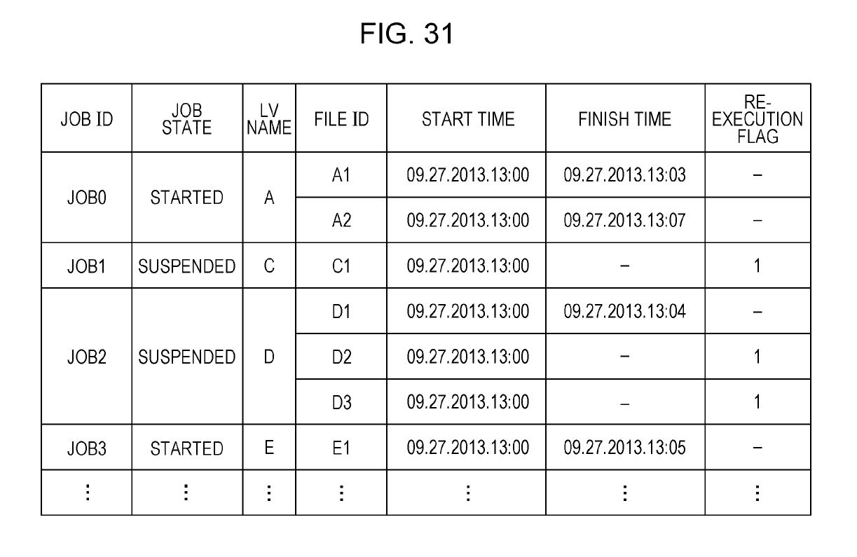

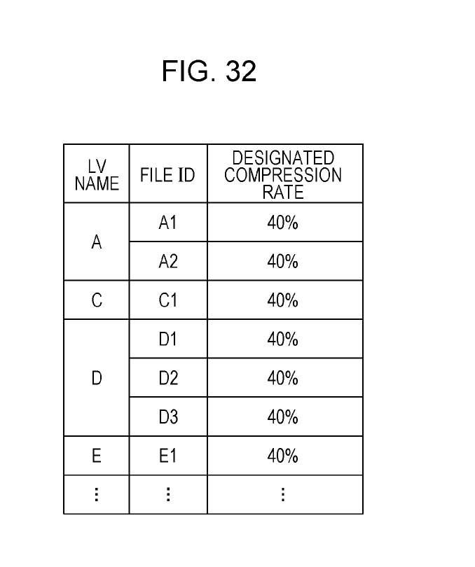

Next, the step of executing the recompression processing will be described. The following description refers to FIGS. 30 to 32. FIG. 30 is a diagram for illustrating updating of the recompression processing job management table (updating after unmount condition determination) according to the third embodiment. FIG. 31 is a diagram for illustrating the updating of the recompression processing job management table (case where main processing occurs during execution of recompression) according to the third embodiment. FIG. 32 is a diagram illustrating an example of notification information to the host computer according to the third embodiment.

When the step of creating the recompression processing job is finished, the virtual library control unit 355 begins execution of the recompression processing according to compression relaxation one by one for the job registered in the recompression processing job management table (compression relaxation).

For example, the virtual library control unit 355 extracts jobs for which the job state is not “completed” (jobs for which the re-execution flag is not “1”) from the jobs registered in the recompression processing job management table (compression relaxation). The virtual library control unit 355 allocates the extracted jobs one by one to the channel control server 304.

At this time, the virtual library control unit 355 allocates the jobs in consideration of the load condition of the channel control server 304. The virtual library control unit 355 acquires load information (for example, CPU usage rate) of the channel control server 304 responsible for compression processing and creates the ICP load information table (refer to FIG. 15) based on the acquired load information.

The virtual library control unit 355 references the ICP load information table and extracts the channel control server 304 with a load state in which the usage rate is lower than the set threshold (for example, 50%). Next, the virtual library control unit 355 determines whether or not the logical volume LV that is the job target registered in the recompression processing job management table is in a state (home state) able to be mounted to the logical drive LD (unmount condition determination process).

In a case where the target logical volume LV is in a state of being mountable to the logical drive LD, the virtual library control unit 355 requests the channel control server 304 with a low load state to mount the logical volume LV. On the other hand, in a case where the target logical volume LV is not in a state of being mountable to the logical drive LD, the virtual library control unit 355 sets the job state of the recompression processing job management table to “suspended” and sets the re-execution flag to “1”.

For example, in a case in which the determination process is executed for the tables illustrated in FIGS. 24 to 27, the recompression processing job management table becomes as illustrated in FIG. 30. In this case the logical volume LV with the LV name C is in the mounted state. Therefore, the virtual library control unit 355 sets the state of the job JOB1 corresponding to the logical volume LV to “suspended” and sets the re-execution flag of the data file C1 to “1”.

Next, the virtual library control unit 355 executes the recompression processing on the channel control server 304 one by one for jobs registered in the recompression processing job management table. At this time, the virtual library control unit 355 executes the recompression processing according to compression relaxation on the channel control server 304 by designating a compression rate a predetermined value (for example, 10%) higher than the designated compression rate disclosed in the intra-LV file compression information table (compression relaxation).

When the recompression processing is completed, the virtual library control unit 355 updates the recompression processing job management table (compression relaxation) and the intra-LV file compression information table.

As above, in the recompression processing according to the third embodiment, the compression rate is reduced a predetermined value at a time. The reason therefor is, when a file is in abruptly in an uncompressed state, there is concern of a lowering the access performance being caused in a case in which the frequency of read access suddenly increases. From the viewpoint of assessing the designated compression rate suitable for the target data file, the recompression processing in which the compression rate is gradually increased as above is suitable.

Here, a case in which the main processing is executed with respect to the logical volume LV during execution of the recompression processing is considered. In this case, the virtual library control unit 355 executes the recompression processing to completion with respect to the data file during execution of the recompression processing. The virtual library control unit 355 executes the main processing with priority without the recompression processing being executed even if the data file with scheduled execution of the recompression processing is on the same logical volume LV.

For example, a case in which the main processing is executed with respect to the logical volume LV with the LV name D partway through the recompression processing with respect to the data file D1 of the job JOB2 registered in the recompression processing job management table (compression relaxation) illustrated in FIG. 30 is considered.

In this case, the virtual library control unit 355 executes the recompression processing of the data file D1 up to completion and suspends the recompression processing of the data files D2 and D3. The virtual library control unit 355 makes the job state of the job JOB2 “suspended” and prioritizes execution of the main processing once the re-execution flag of the data files D2 and D3 is set to “1”, as illustrated in FIG. 31.

A job with the job state “suspended” is thereafter re-executed. In a case where there is no job with a job state of “suspended”, the virtual library control unit 355 notifies the host computer 100 of the information of the logical volume LV on which the recompression processing is executed.

For example, the virtual library control unit 355, as illustrated in FIG. 32, notifies the host computer 100 of the LV name of the logical volume LV on which the recompression processing is executed, the file ID of the data file on which the recompression processing is executed, and the designated compression rate designated during recompression processing. When notification to the host computer 100 is completed, the virtual library control unit 355 finishes the recompression processing according to the compression relaxation.

Above, the functions of the virtual library control unit 355 according to the third embodiment were described.

3-2. Processing Flow

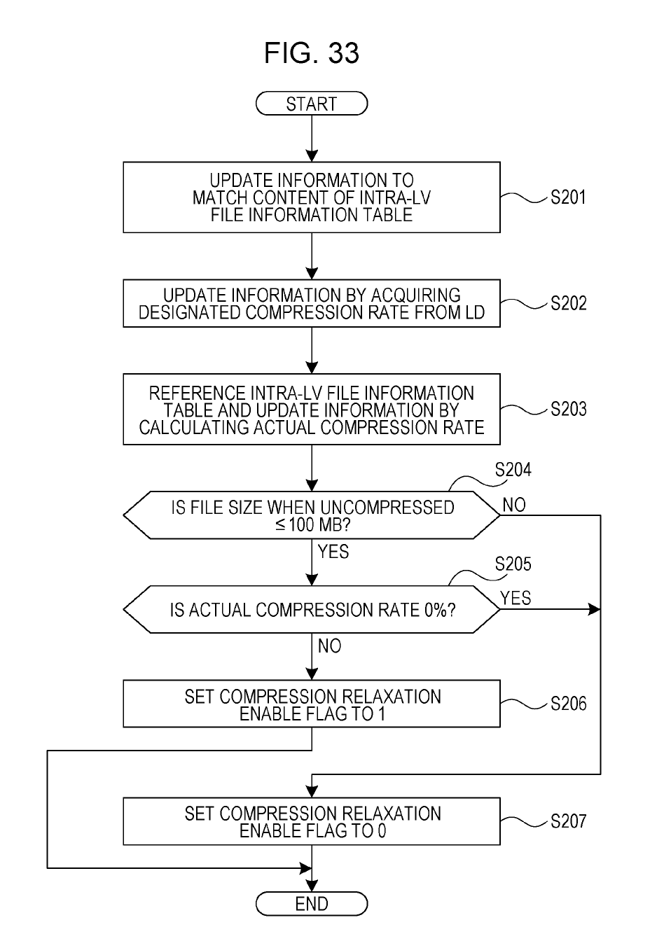

Next, the processing flow according to the update of the intra-LV file compression information table (compression relaxation), creation of the recompression processing job according to compression relaxation, and the execution of the recompression processing according to compression relaxation will be described in order with reference to FIGS. 33 to 37.

3-2-1. Update of Intra-LV File Compression Information Table

The processing flow according to the update of the intra-LV file compression information table (compression relaxation) will be described with reference to FIG. 33. FIG. 33 is a flowchart illustrating update processing of the intra-LV file compression information table according to the third embodiment.

(S201) The database control unit 354 updates the information of the intra-LV file compression information table (compression relaxation) so as to match the content of the intra-LV file information table.

(S202) The database control unit 354 acquires the designated compression rate used during the write processing from the logical drive LD and updates the information on the designated compression rate included in the intra-LV file compression information table (compression relaxation) with the acquired designated compression rate.

(S203) The database control unit 354 references the intra-LV file information table and calculates the actual compression rate using the pre-compression data size and the post-compression data size. The database control unit 354 updates the information of the actual compression rate stored in the intra-LV file compression information table (compression relaxation) with the calculated actual compression rate.

(S204) The database control unit 354 references the intra-LV file information table and determines whether or not the file size when the data file is uncompressed is the set size (for example, 100 MB) or less. In a case where the file size when uncompressed is the set size or less, the process proceeds to S205. On the other hand, in a case where the file size when uncompressed exceeds the set size, the process proceeds to S207.

(S205) The database control unit 354 determines whether or not the actual compression rate is 0%. In a case where the actual compression rate is 0%, the process proceeds to S207. On the other hand, in a case where the actual compression rate is not 0%, the process proceeds to S206.

(S206) The database control unit 354 sets the compression relaxation enable flag corresponding to the target data file to “1” from the information included in the intra-LV file compression information table (compression relaxation). When the process in S206 is completed, the series of processes illustrated in FIG. 33 finishes.

(S207) The database control unit 354 sets the compression relaxation enable flag corresponding to the target data file to “0” from the information included in the intra-LV file compression information table (compression relaxation). When the process in S207 is completed, the series of processes illustrated in FIG. 33 finishes.

3-2-2. Creation of Recompression Processing Job

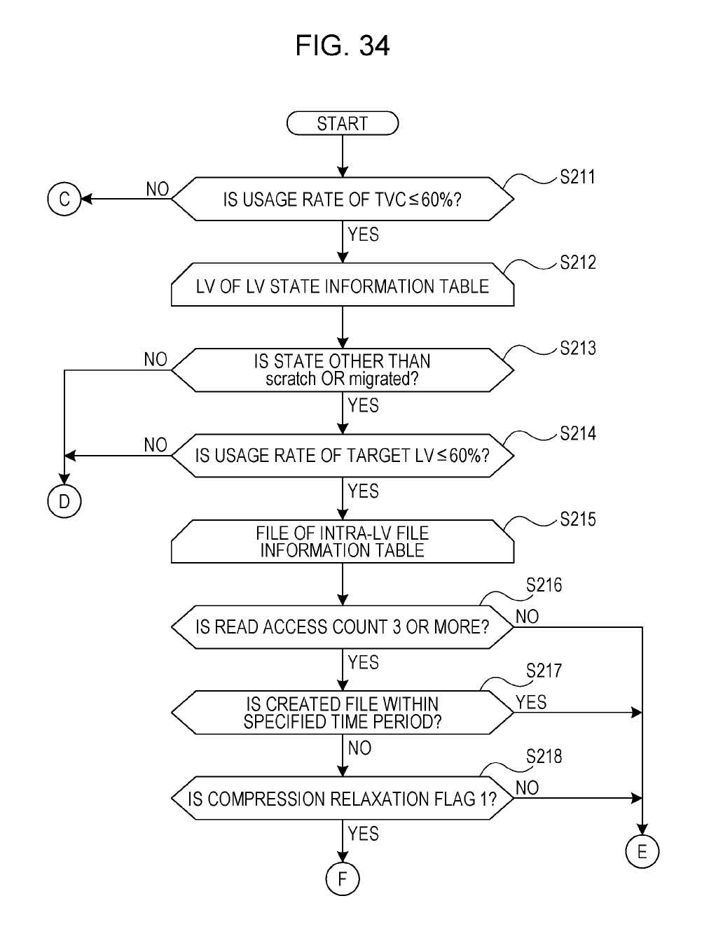

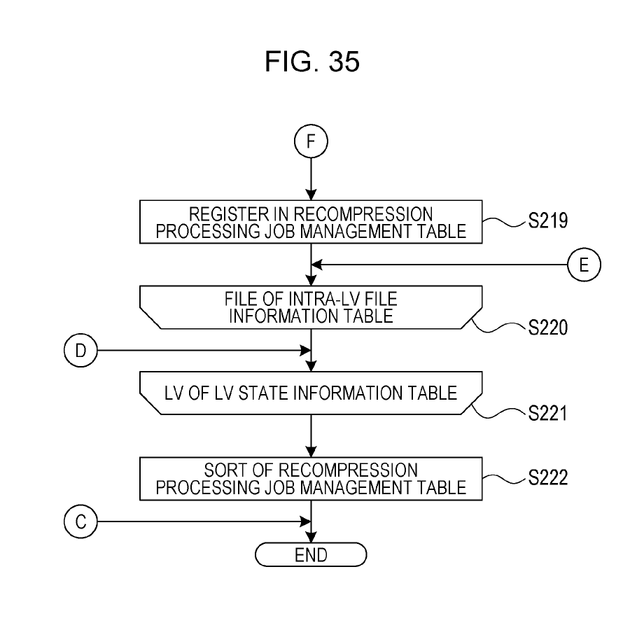

The processing flow for execution of creating the recompression processing job according to compression relaxation will be described with reference to FIGS. 34 and 35. FIG. 34 is a first flowchart illustrating a recompression job creation process according to the third embodiment. FIG. 35 is a second flowchart illustrating a recompression job creation process according to the third embodiment.

(S211) The virtual library control unit 355 determines whether or not the usage rate of the disk array 301 is the set threshold ThV2 (for example, 60%) or less. In a case where the usage rate of the disk array 301 is the threshold ThV2 or less, the process proceeds to S212. On the other hand, in a case where the usage rate of the disk array 301 exceeds the threshold ThV2, the series of processes illustrated in FIGS. 34 and 35 finishes.

(S212, S221) S212 is the start point of the processing loop that executes the processing between S212 and S221 in FIG. 35 on each logical volume LV for all of the logical volumes LV registered in the intra-LV file information table. S221 is the finishing point of the processing loop.

(S213) The virtual library control unit 355 determines whether or not the target logical volume LV is in a state other than “scratch, migrated”. In a case in which the target logical volume LV is in a state other than “scratch, migrated”, the process proceeds to S214. On the other hand, in a case in which the target logical volume LV is not in a state other than “scratch, migrated”, the process proceeds to S221 in FIG. 35.

(S214) The virtual library control unit 355 determines whether or not the usage rate of the logical volume LV that is the target in S212 is the set threshold ThV3 (for example, 60%) or less. In a case where the usage rate of the logical volume LV is the threshold ThV3 or less, the process proceeds to S215. On the other hand, in a case where the usage rate of the logical volume LV exceeds the threshold ThV3, the process proceeds to S221 in FIG. 35.

(S215, S220) S215 is the start point of a process loop that executes the processes between S215 and S220 in FIG. 35 on each data file for all of the data files registered in the intra-LV file information table relating to the target logical volume LV. S220 is the finishing point of the processing loop.

(S216) The virtual library control unit 355 determines whether or not the read access count for the target data file is the set threshold ThR2 (for example, three times) or higher. In a case where the read access count is the set threshold ThR2 or higher, the process proceeds to S217. On the other hand, in a case where the read access count is less than the set threshold ThR2, the process proceeds to S220 in FIG. 35.

(S217) The virtual library control unit 355 determines whether or not the target data file is a data file created within the specified time period. In a case where the target data file is a data file created within the specified time period, the process proceeds to S220 in FIG. 35. On the other hand, in a case where the target data file is not a data file created within the specified time period, the process proceeds to S218.

(S218) The virtual library control unit 355 determines whether or not the compression relaxation enable flag corresponding to the target data file is “1”. In a case where the compression relaxation enable flag corresponding to the target data file is “1”, the process proceeds to S219 in FIG. 35. On the other hand, in a case where the compression relaxation enable flag corresponding to the target data file is not “1” (case where the compression relaxation enable flag is “0”), the process proceeds to S220 in FIG. 35.

(S219) The virtual library control unit 355 registers the target data file in the recompression processing job management table (compression relaxation). When the process of S219 is completed, the process proceeds to 220 and the processes from S215 onwards are repeatedly executed for a different data file by the processing loop. Even in a case in which the process arrives at S221, the processes from S212 onwards are repeatedly executed for a different logical volume LV by the processing loop.

(S222) When the processing loop of S212 and S221 is finished, the process proceeds to S222. In the process of S222, the virtual library control unit 355 sorts the recompression processing job management table (compression relaxation) in descending order of priority degree designated in the priority degree information. When the process in S222 is completed, the series of processes illustrated in FIGS. 34 and 35 finishes.

3-2-3. Execution of Recompression Processing

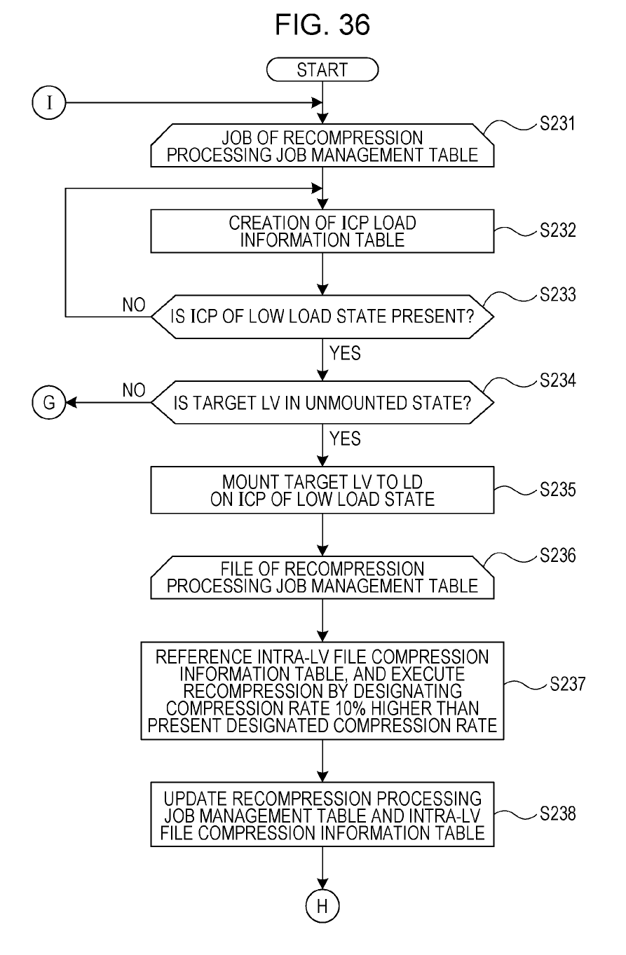

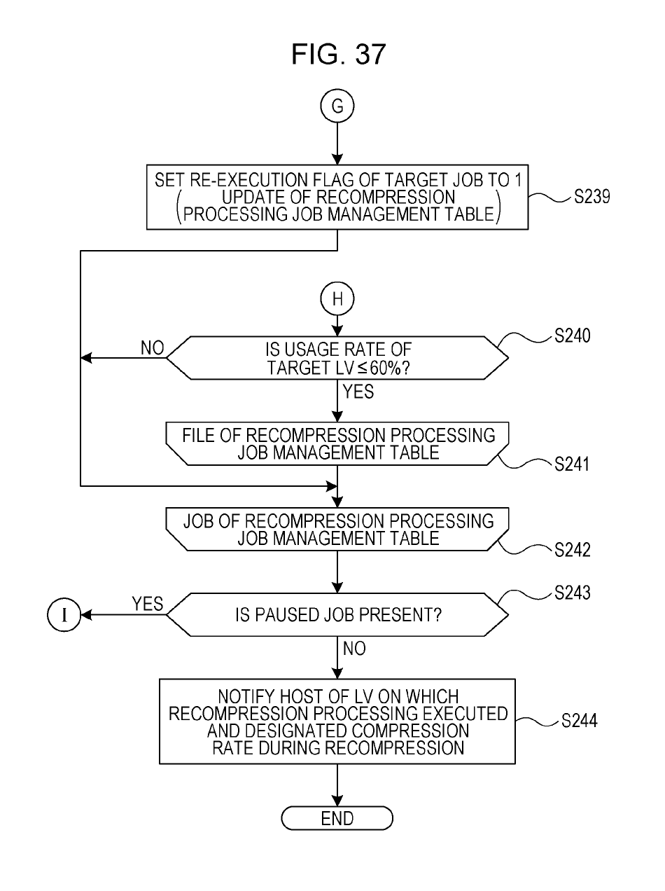

The processing flow for execution of the recompression processing according to compression relaxation will be described with reference to FIGS. 36 and 37. FIG. 36 is a first flowchart illustrating the flow of recompression processing according to the third embodiment. FIG. 37 is a second flowchart illustrating the flow of recompression processing according to the third embodiment.

(S231, S242) S231 is the starting point of a processing loop that executes the processes between S231 and S242 in FIG. 37 on each job for all of the jobs registered in the recompression processing job management table (compression relaxation). S242 is the finishing point of the processing loop.

(S232) The virtual library control unit 355 acquires the load information of the channel control server 304 and creates the ICP load information table based on the acquired load information.

(S233) The virtual library control unit 355 references the ICP load information table and determines whether or not the channel control server 304 with a low load state is present. In a case where the channel control server 304 with a low load state is present, the process proceeds to S234. On the other hand, in a case where the channel control server 304 with a low load state is not present, the process proceeds to S232.

(S234) The virtual library control unit 355 determines whether or not the logical volume LV that is a job target is in an unmounted state (home state). In a case in which the logical volume LV that is the job target is in the unmounted state (home state), the process proceeds to S235. On the other hand, in a case in which the logical volume LV that is the job target is not in the unmounted state (home state), the process proceeds to S239 in FIG. 37.

(S235) The virtual library control unit 355 mounts the logical volume LV that is the job target to the logical drive LD on the channel control server 304 with a low load state.

(S236, S241) S236 is the starting point of a processing loop that executes the processes between S236 and S241 in FIG. 37 on each data file for all of the data files registered in the recompression processing job management table (compression relaxation). S241 is the finishing point of the processing loop.

(S237) The virtual library control unit 355 references the intra-LV file compression information table (compression relaxation) and executes recompression on the channel control server 304 by designating a compression rate higher than the current designated compression rate by a predetermined value ΔC2 (for example, 10%).

(S238) The virtual library control unit 355 updates the recompression processing job management table (compression relaxation) and the intra-LV file compression information table (compression relaxation). For example, the virtual library control unit 355 updates the information such as the job state and finish time of the target job. The virtual library control unit 355 updates the value of the designated compression rate with the compression rate designated during execution of the recompression. When the process of S238 is completed, the process proceeds to S240 in FIG. 37.

(S239) The virtual library control unit 355 updates the recompression processing job management table (compression relaxation). At this time, the virtual library control unit 355 sets the re-execution flag of the target job to “1”. The virtual library control unit 355 sets the job state of the target job to “paused”. When the process of S239 is completed, the process proceeds to S242 and the processes from S231 onwards are repeatedly executed for a different job by the processing loop.

(S240) The virtual library control unit 355 determines whether or not the usage rate of the logical volume LV that is a target is the set threshold ThV3 (for example, 60%) or less.

In a case where the usage rate of the logical volume LV is the threshold ThV3 or less, the process proceeds to S241 and the processes of S236 and onwards are repeatedly executed by the processing loop. On the other hand, in a case where the usage rate of the logical volume LV exceeds the threshold ThV3, the process proceeds to S242 and the processes of S231 and onwards are repeatedly executed by the processing loop.

(S243) When the processing loop of S231 and S242 is finished, the process proceeds to S243. In the process in S243, the virtual library control unit 355 references the recompression processing job management table (compression relaxation) and determines whether or not a job with a job state of “paused” is present. In a case where a job with a job state of “paused” is present, the process proceeds to S231. On the other hand, in a case where a job with a job state of “paused” is not present, the process proceeds to S244.

(S244) The virtual library control unit 355 notifies the host computer 100 of the information pertaining to the logical volume LV on which the recompression processing according to compression relaxation is executed and the designated compression rate during recompression. When the process in S244 is completed, the series of processes illustrated in FIGS. 36 and 37 finishes.

Above, although the preferred embodiments have been described while referencing the attached diagrams, it is needless to say that the disclosure is not limited to these examples. It is clear that a person skilled in the art may conceive of various changes or modifications within the scope disclosed in the claims and it is understood that these changes or modifications naturally fall in the technical scope of the disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus, comprising:
a storage unit configured to store information of a designated compression parameter value and information of a compression parameter value calculated from a data size of a data file with respect to the data file compressed with the designated compression parameter value that represents a reduction degree of the data size and stored in a storage device; and
a controller configured to compare, in terms of the reduction degree, the designated compression parameter value and the calculated compression parameter value for each data file, and set a recompression target by extracting the data file in which the calculated compression parameter value is lower than the designated compression parameter value.

2. The control apparatus according to claim 1, wherein
the controller designates the compression parameter value as the compression parameter value to be used in recompression in a case where the compression parameter value lower than the designated compression parameter value by a set value is higher than the maximum compression parameter value set, and designates the maximum compression parameter value as the compression parameter value to be used in recompression in a case where the compression parameter value is lower than the maximum compression value.

3. The control apparatus according to claim 1, wherein
the storage unit stores information pertaining to an access frequency to the data file and
the controller sets, as the recompression target, the data file for which the calculated compression parameter value is the designated compression parameter value or higher and for which the access frequency is lower than a set first threshold.

4. The control apparatus according to claim 1, wherein
the storage device is a logical volume, and
the controller sets, as the recompression target, the data file in the logical volume that is in a state of being mountable to a logical drive and has not been mounted to the logical drive.

5. The control apparatus according to claim 4, wherein
the controller compares empty capacity of a cache region that stores the logical volume that is in the state of being mountable to the logical drive and a set second threshold, and causes recompression processing to be executed in a case in which the empty capacity of the cache region is lower than the second threshold.

6. The control apparatus according to claim 4, wherein
the storage unit stores information pertaining to an access frequency to the data file, and
the controller compares empty capacity of a cache region that stores the logical volume that is in the state of being mountable to the logical drive and a set third threshold, extracts the data file for which the access frequency is higher than a set fourth threshold in a case in which the empty capacity of the cache region is higher than the third threshold, and recompresses the extracted data file with a compression parameter value lower than the designated compression parameter value.

7. The control apparatus according to claim 1, wherein
the controller acquires information that indicates a processing load on each of a plurality of servers able to compress the data file, and causes the server with the processing load lower than a set third threshold to execute recompression processing.

8. A recompression control method by a computer, comprising:
storing information of a designated compression parameter value and information of a compression parameter value calculated from a data size of a data file with respect to the data file compressed with the designated compression parameter value that represents a reduction degree of the data size and stored in a storage device,
comparing, in terms of the reduction degree, the designated compression parameter value and the calculated compression parameter value for each data file, and
setting a recompression target by extracting the data file in which the calculated compression parameter value is the designated compression parameter value or higher.

9. The recompression control method according to claim 8, further comprising:
causing the computer to designate the compression parameter value as the compression parameter value to be used in recompression, in a case where the compression parameter value lower than the designated compression parameter value by a set value is higher than the maximum compression parameter value set, and to designate the maximum compression parameter value as the compression parameter value to be used in recompression in a case where the compression parameter value is lower than the maximum compression value.

10. The recompression control method according to claim 8, wherein
the storage unit stores information pertaining to an access frequency to the data file, and
the computer sets, as the recompression target, the data file for which the calculated compression parameter value is the designated compression parameter value or higher and for which the access frequency is lower than a set first threshold.

11. The recompression control method according to claim 8, wherein
the storage device is a logical volume, and
the computer sets, as the recompression target, the data file in the logical volume that is in a state of being mountable to a logical drive and has not been mounted to the logical drive.

12. The recompression control method according to claim 11, wherein
the computer compares empty capacity of a cache region that stores the logical volume that is in the state of being mountable to the logical drive and a set second threshold, and causes recompression processing to be executed in a case in which the empty capacity of the cache region is lower than the second threshold.

13. The recompression control method according to claim 11, wherein
the storage unit stores information pertaining to an access frequency to the data file, and
the computer compares empty capacity of a cache region that stores the logical volume that is in the state of being mountable to the logical drive and a set third threshold, extracts the data file for which the access frequency is higher than a set fourth threshold in a case in which the empty capacity of the cache region is higher than the third threshold, and recompresses the extracted data file with a compression parameter value higher than the designated compression parameter value.

14. The recompression control method according to claim 8, wherein
the computer acquires information that indicates a processing load on each of a plurality of servers able to compress the data file, and causes the server with the processing load lower than a set third threshold to execute recompression processing.

15. The control apparatus according to claim 7, wherein
in a case in which a plurality of servers with a processing load lower than the third threshold are present, the controller causes the server with the lowest processing load to execute the recompression processing.

16. A control apparatus, comprising:
a storage unit configured to store information of a designated compression parameter value, information of a compression parameter value calculated from a data size of a data file, and information indicating an access frequency to the data file with respect to data files compressed with the designated compression parameter value that represents a reduction degree of the data size and stored in a storage device, and
a controller configured to extract, from among the data files, a data file in which the access frequency is higher than a frequency set in advance, and set the extracted data file as a recompression target to have a compression parameter value lower than the designated compression parameter value in terms of a reduction degree.

17. The control apparatus according to claim 16, wherein
the controller excludes, from the recompression target, a data file for which the data size in an uncompressed state is larger than a preset size from among the data files that are recompression targets.

18. The control apparatus according to claim 16, wherein
the controller starts recompression processing for the data file that is a recompression target in a case in which empty capacity of the storage device is a preset capacity or more.

19. The control apparatus according to claim 1, wherein
the controller includes a memory and a processor coupled to the memory.
